(19) United States
(12) Patent Application Publication
(10) Pub. No.: US 2018/0318918 A1
(43) Pub. Date: Nov. 8, 2018

(54) Method and Device for Overall Temperature Control Close to the Mould Cavity of Temperature-Controlled Shell-Type Moulds, Using Intercommunicating Media in Polyhedral Spaces

(71) Applicants: Torsten Schmidt, Annaberg-Buchholz (DE); Uwe Richter, Gröden (DE)

(72) Inventor: Uwe Richter, Gröden (DE)

(21) Appl. No.: 15/773,558

(22) PCT Filed: Nov. 4, 2016
(86) PCT No.: PCT/DE2016/100524

§ 371 Date: May 4, 2018

(30) Foreign Application Priority Data
Nov. 4, 2015 (DE) 10 2015 118 901.1

(51) Int. Cl. B22D 17/22; B22C 9/06; B29C 45/73

(52) U.S. Cl. CPC B22D 17/2218; B29C 45/73; B22C 9/065

(57) ABSTRACT

Method for near-contour surface temperature control of shell-shaped molds (14) with mold rim zones (1), wherein the temperature control of the mold (14) on a near-contour temperature control surface (4) with adjacent, web-like or wall-like separated subareas (4.i) is effected from the respective rear space (3) of the mold rim zones (1) of the mold (14) and/or the respective mold rim zone (1) of the mold (14). The shell-shaped molds (14) are designed in two or more parts with the respective mold rim zones (1). Specifically, the temperature control as cooling in the form of temperature control on the temperature control surface (4) is locally different in subareas (4.i). The temperature control surface (4) is effected in accordance with the temperature ranges of convection, bubble evaporation, partial and/or stable film evaporation of the liquid cooling fluid water.

### CROSS REFERENCE TO RELATED APPLICATIONS

This application is the U.S. national stage of International Application No. PCT/DE2016/100524, filed on 2016 Nov. 4. The international application claims the priority of DE 102015118901.1 filed on 2015 Nov. 4; all applications are incorporated by reference herein in their entirety.

### BACKGROUND

The invention relates to a method for improving the near-contour temperature control of shell-shaped moulds. This temperature control is performed either by cooling and/or external heating of the shell-shaped mould from its back. The shell-shaped mould may thereby be shaped so that its rear largely follows the contour or engraving. A shell-shaped mould thereby represents a mould that, compared to conventional moulds, is distinguished by much thinner mould walls. The designation of the individual parts of a shell-shaped mould is handled differently. As any other mould, the shell-shaped mould consists of at least two parts. One part is principally composed of at least one solid area and one mould rim zone each.

The near-contour positioning of devices for heat transfer and thus the faster temperature control of the workpieces to be formed is better possible with a mould rim zone than with conventional moulds.

Polyhedron-type spaces on the rear of the mould rim zone allow for overall and local temperature control where fluid phases of the coolants and heating agents can communicate with each other.

The method according to the invention can be used for the near-contour overall temperature control of shell-shaped moulds. Temperature control thereby takes place via the temperature control surface of the mould rim zone. It represents the rear of the mould rim zone.

The method concerns the temperature control of casting moulds for pressure die-casting. However, it can also be used for low pressure and gravity chill casting, injection moulding as well as moulds for the manufacture of glass components. Furthermore, moulds of reshaping technology can be temperature-controlled using the method according to the invention. The heating energy to be introduced or dissipated via cooling is understood as thermal energy. According to the new procedure it may locally adapted according to the technological requirements. The procedure preferably concerns metal moulds. The mould may thereby consist of multiple parts; the procedure also applies to movable or immovable sliders and cores.

The procedure allows affecting and improving the mechanical properties of the workpiece to be formed in a targeted manner. Furthermore, by employing the temperature control according to the invention, improvement of cavity filling of the mould, that is, its mould cavity, becomes possible in a targeted manner. The exact filling of thin and thick cavities is possible here in the same manner. Furthermore, when using the procedure, the thermal-mechanical stresses of the mould itself can be reduced. Its engraving, that is, the front of the mould rim zone, is less prone to wear than the known procedures of the state of technology.

The procedure concerns such forming processes where the thermal energy of the process, that is, the process heat introduced in the forming process, must be largely dissipated via the temperature control surface of the mould rim zone and thus via the rear space of the mould, including corresponding state change. Smaller amounts of the dissipation of thermal energy of the process take place as losses via the solid area of the mould to the forming machine and the environment or similar. They are not considered, likewise, the caloric content of the workpiece that has been removed from the cavity while still hot but with stable shape.

Likewise, partial areas of the temperature control surface can receive external energy in a targeted manner in the form of heating energy via the rear space.

Temperature control of the temperature control surface is possible with fluid media.

The classic usual procedure for the cooling of casting tools for pressure die-casting essentially constitutes twofold cooling. Because not the entire process heat, that is, the heat up to the removal of the workpiece, can be dissipated via cooling of the rear space of the mould, the engraving or contour, that is, the workpiece surface, must be cooled further after removing the cast part.

Different than cooling in each process cycle, heating of the mould is usually only performed in the initial phase of the complete process by preheating the mould. This shall avoid damages of the engraving from excessive thermal gradients during the first forming process. This can be done by heating the engraving with radiators or similar or by heating the rear space through directing hot liquids via the cooling channels provided there.

First, classical cooling takes place by introducing cooling geometries into the rear space of the mould. This is done in the form of straight holes according such as through holes and blind holes which are usually made with eroding and machining methods. Cooling fluid is directed through these holes. The cooling fluid thus flows through the holes in the kind of a channel. The introduced channel geometries must have a certain distance from the engraving. The distance between neighbouring channels must also have minimum dimensions. Channel dimensions, flow pattern as well as the properties of the temperature control medium, such as water or oil, and the mould material determine the amount of heat that can be transferred. At this, cooling is usually subject to major geometrical restrictions since uniform cooling of a geometrically rather alternating engraving via straight cooling channels or blind holes is only possible only to a limited extent for nearly pointed cooling.

Especially the cooling from the rear space is not sufficient. As a second measure, cooling via the contour or engraving is thereby performed: After removing the cast part from the cavity, a release agent-water mixture is therefore applied to the engraving for an extended period with high air pressure and the temperature of the mould surface and the mould are thereby lowered further. The water is mixed with release agent, which shall prevent the cast metal from sticking to the mould surface. With this shock cooling and the subsequent abrupt heating by adding the hot melt on the engraving the mould surface is subjected to increased wear.

To improve this condition of classic double cooling of moulds, efforts for the manufacturing of relatively thin mould masks for ties can be seen in patent literature. They shall follow the contour of the workpiece and therefore temperature-control it near-contour, usually cooling it. It is apparent from patent literature that through the pursued proximity to the contour of the cooling system the mould is cooled alone from the rear space and additional cooling via the engraving shall be dispensed with. The mould is to be designed as mask. A temperature controlled area lies behind the mask. Because the mould masks are thin, there is also a solid area of the mould. It shall guarantee stability. This arrangement produces a near-contour cooled thin mould.

A mask mapping the contour of the workpiece and delimiting the cavity of the mould is presented in DE 10 2012 024 051 A1. Several cavities are located directly under the mask to channel the temperature control liquid. This temperature control area is then followed by the solid area of the pressure die-casting die. The mask is supported on the solid area by supports. Ejector-receiver units, sealed tightly for liquids against the temperature control cavity, also assume support functions. The support units of the mask are bolted together to guarantee high mechanical safety of the mould. It is emphasized that liquid and gaseous fluids can be used for cooling.

In EP 1 403 029 A1 a near-contour cooling mould with flat cooling channels, which are located closely behind the contour of the cavity and following it, is presented. Cooling fluid flows through them.

DE 10 2006 008 359 B4 presents a casting tool which is also manufactured by casting. It presents a negative of the cast part, manufactured in an additional step, including near-contour cooling geometry. For this purpose, the mould features reinforcing ribs in the rear space permitting a division into cooling points. Fluid may flow through them individually or as cascades. The intention is to allow cooling or heating with coolant or heating agents, depending on the amount of heat generated in the cast part. According to the inventor and the presentation, the flow takes place classically in channel fashion. The invention has weak points: The intended flow pattern—with entries and exists of the flow in the segments—would produce corners and edges with weak flows and that cannot be regulated in the individual segments. This already results from the contour proximity of the channel and its strongly irregular channel base that is supposed to follow the contour. This would cause the flow to break and result in poor flows up to dead spaces. The channel would become very hot there. If the cooling system is open under pressure, steam-water mixtures would form at the superheated channel locations, which would discharge towards the opening of the cooling system. If the cooling system is closed, local heating, for example to approx. 700° C. for aluminium casting, would lead to a strong increase in pressure, as the pressure could not be reduced due to the system being closed.

DE 12 16 496 B describes a mould in the form of an outer shell or zone, which is produced by galvanoplastic means with a pack of granular sintered metal applied to its inner surface. This sintered grain should have similar physical properties as the metal of the mould, e.g. shrinkage or conductivity. Cooling coils can be introduced into this package. Then low-melting metal is poured into the package by centrifugal casting. In this way, shrinkage and gap formation to the mould is supposed to be prevented. In DE 10 2005 030 678 A1 a mould shell with back lining is revealed. Channel structures, material layers, open-pored structures and thermally conductive masses are introduced into the back lining. The combination of these elements in the back of the mould shell should result in a uniform temperature. These devices alone make the tool multi-part. No statement is made about the back lining and its guarantee of the stability of the mould. Also, the very probably poor heat transfer of the installed temperature control elements is not discussed.

DE 10 2005 030 814 B4 reveals the production of a casting mask that has the outer contour of the casting. A solid area is cast onto it from a metal or alloy. The metal cooling pipes previously attached to the casting mask can be cast into these in a material-locking manner. Alloys with a melting point below that of the mask are preferred. Difficulties of the material-locking connection to the casting mask are not reported.

DE 10 2007 005 257 A1 describes a coolable mould for form hardening of a workpiece, which consists of two parts. The first part is designed as a contouring mould shell. The second part is designed as a core. Between the core and the mould shell is a cooling cavity through which a cooling medium flows to cool the workpiece.

The WO 2011026162 A1 describes an injection mould in which a cavity is arranged behind a mould shell, which serves to pass through cooling fluid. Behind it is the solid area of the mould as an abutment. The cooling cavity between the mould shell and the solid area is filled with a support layer to provide support against the forces occurring during the moulding process. This transfers the forces during the forming process to the solid area behind the cooling cavity. The cooling medium, which can be water or oil, etc., flows through this support layer and should therefore dissipate the heat from the mould shell.

The cooling of small mould areas is also reported about. JP2003164957A, JP2004154796 and JP2007307593 A present solutions designed to cool small, bore-like areas of the mould. A double-tube cooling insert, consisting of an inner and an outer tube, is installed into the mould via a drilled hole in the rear chamber. The drill hole reaches up to a few millimetres to the engraving of the casting mould. A cooling fluid, such as water or a water-air mixture, is passed through the thin inner tube in the form of a free jet from a pump under increased pressure to the face of the borehole. The back-flowing fluid returns to the cooling system via the outer tube of the double tube arranged further back. This cooling system, often referred to as “jet cooling”, is only suitable for small areas of the contour of the mould in the form of the face of the bore hole and not for continuous, flat and extensive areas of the mould engraving. It is used for cooling hot spots. This point cooling via the drill hole face or the very small face of the bore is of course close to the contour. It is difficult to achieve a larger, even water coverage with a free jet that deviates from the bore hole face or small circular surfaces. The main characteristic of the free jet is the exit of a single jet from a nozzle into a liquid or gaseous medium. Depending on the nozzle used, it expands with increasing distance from the nozzle. On larger areas, such as the face of a borehole or similar, the free jet will spray uncontrollably after it hits the borehole. An even wetting of flat contours, furthermore with an almost uniform liquid film, is completely impossible with the free jet. In most cases, areas close to the contour are also very changeable, because the temperature control surface follows the engraving close to the contour. The surface geometry of the temperature control surface varies greatly. Furthermore, there are always angular areas or corners of strongly changing geometry on the temperature control surface, where the wide-spraying cooling water of a free jet would swirl, flow over the temperature control surface without wetting, or dead spaces would form.

Therefore an even and complete wetting of irregular and larger areas is impossible: Stable control of the temperature control surface with regard to its temperature control and transfer of the corresponding desired heat or cooling intensity would not be possible. The target group of the free jet in moulding technology are hot spots and narrow cores protruding from the mould, in which a bore is geometrically suitable and cooling with a free jet is advantageous. This is why jet beam is limited to borehole-like recesses, as can also be seen from the mainly Japanese quotations of patent literature.

Furthermore, moulds are revealed, in the contour proximity of which a cooling system is poured in, which was previously manufactured externally. DE 10 2010 017 014 A1 describes a process for the near-contour arrangement of externally manufactured cooling channel geometries. These can have a different appearance from the classic round tube cross-section geometry. The mould is cut close to the contour up to the thickness of a shell, for example by milling or eroding, and the previously produced cooling channel geometry is fixed to the shell side facing away from the contour, i.e. in the rear area. Finally, the channel geometry is poured into the back of the mould. The process used to produce the cooling geometry is a generative or 3D process: Selective laser melting. Any geometries can be produced. However, the process is limited to smaller sizes with an installation space of approx. 200×200×200 mm. With the MPA process, an example of a thermal spraying process, sizes up to 500 mm in diameter can be produced. At present, it is not yet possible to completely produce larger tool moulds from tool steel. Smaller parts of tool moulds are produced, such as cores and slides. These can be equipped with cooling channels.

In DE 741 76 10 U, a near-contour heating/cooling system is proposed. Heating and cooling channels are installed separately from the mould in one block. For this purpose, holes are drilled close to each other. Cooling liquids but also electric heating elements can be used for the heating side. Water and oil are preferred for cooling. The walls of the heating and cooling pipes are arranged close together. The block equipped externally with the heating/cooling system is then installed in the mould.

Furthermore, a process for the near-contour cooling of cores and moulds for pressure and injection moulds is revealed in DE 10 2012 10 68 71 B4. For this purpose, the rear space is released up to a shell beforehand. For cooling and heating, separate pipe systems or flow-through cooling geometries and electrical heating elements are proposed. Both are installed geometrically close together on the rear wall. After fixing to the shell in the back of the mould, they are poured there.

DE 101 59 456 A1 describes a near-contour mould in which a pipe is laid close to the contour in the previously freed rear space of a mould. This is cast with the same material of the mould in a form-fit manner. Difficulties of the material-locking connection to the mould are not mentioned.

AT 512 091 A1 describes another possibility of inserting geometrically freely selectable cooling channels into the mould. It is a lamellar mould. With metal lamellae placed next to each other, such as hot-work steel sheets, a mould cavity is depicted, as in a conventional mould casting tool. The goal here is to insert freely selectable, near-contour channels for the possibility of flow through with cooling liquids. In the individual lamella, the channel geometry can be changed relative to the adjacent lamella. Thus, the channel geometry is changed in lamella thickness. For the assembly of the lamella to the finished stack of sheets or to the mould, screwing, soldering, welding, gluing and simple pressing of the lamella packs together are suggested.

DE 28 50 229 A1 proposes cooling by evaporation of cooling water in communicating secondary channels. Initially, there are main channels from which the subchannels extend close to the contour to the rear side of the mould surface. The main channels are connected to a pump system with cooling water. The temperature of the cooling medium water in the main channel is maintained at 200° C. and the increased pressure corresponding to this temperature. The set pressure is regulated by adjusting a pressure relief valve. In the subchannels, the liquid evaporation takes place at a given pressure under thermal influence in the forming process. The steam increases the pressure, the pressure valve opens and releases the excess pressure into a tank. A pump now feeds exactly as much cold cooling water from the tank into the main channel as evaporates in the sub channels during cooling. Thus, temperature control of the cooling water in the channels is to be dispensed with.

DE 35 02 895 A1 reveals a mould for improved heat dissipation in die-casting moulds. This is shell-shaped from the back and runs into the solid area of the mould. The solid area in the rear area is closed off by an end part or plate. A heat exchange chamber is thus formed between the shell and the end plate. Depending on the thickness of the casting and the heat to be dissipated, the wall thickness of the shell is determined. This is done in inverse proportion. Depending on the thickness of the shell and the casting, little or much heat is dissipated via the shell per time unit. Inside the heat exchange chamber there is a liquid heat exchange medium under high pressure. This usually refers to water that is under high pressure. As a result of casting, water should evaporate on the wall of the heat exchange chamber facing the cavity, thereby dissipating the casting heat. Only as much water should be added to the high-pressure chamber as has evaporated in the heat exchange chamber. The evaporating water should be discharged through a valve. A corresponding amount of liquid water is fed into the heat exchange chamber through another valve. Thus only a minimal water exchange in the high pressure chamber should be necessary. As a result, the coolant water is supplied to the heat exchange chamber in stages or discontinuously, corresponding to the escaped steam.

EP 2388086 describes in a similar way a shell-shaped heat exchange chamber for temperature control of die-casting moulds with liquid fluid. The fluid flowing through the heat exchange chamber flows over the shell in a flow-promoting manner.

EP 0 033 901 A1, for example, reveals an improved process for the near-contour cooling of die-casting moulds using thin-walled moulds made of a metallic material with high thermal conductivity. The coolant in the form of evaporable liquids acts on the thin-walled mould shells from a cooling chamber of the die-casting mould adjacent behind the mould shells. This is injected onto the mould shells via nozzles. During the cooling process, it can change to the vapour state on the mould wall. The axial displacement of the nozzles is intended to enable more intensive or less intensive cooling of certain areas of the mould shell.

In most of the previous solutions for near-contour cooling of moulds, cooling geometries are proposed which are usually arranged behind a mould mask. These can be geometrically different from the classical pipe channel and follow the contour of the cavity. Their basic type of flow is that of the channel. Cooling fluid flows from a channel input to a channel output. These also include the proposed cooling segments, which contain individual chambers on the back of a mould mask. Here, the cooling fluid also flows through the individual chambers like a channel from one chamber inlet to one chamber outlet. Or near-contour cooling inserts and cooling tubes for the rear area of the mould are suggested, which are also flowed through in the form of a channel. The lamellar design of the moulds also aims at the insertion of channel-like cooling structures. According to DE 28 50 229 A1, the water flows through subchannels close to the contour, even if some of it is to evaporate there.

Another characteristic of the previous solutions for channel-like near-contour cooling is that the cooling medium increasingly heats up on the hot wall on its flow path from the inlet to the outlet. This is intentional. In general, thermal energy flows continuously from or to the cooling channel from the engraving of the mould. Uniform cooling of larger contiguous geometric areas with a cooling fluid of the same initial temperature is therefore not possible. The cooling fluid in channels changes its temperature continuously. This constantly changes its potential to absorb heat. Even if the cooling fluid evaporates in the channels according to DE 28 50 229 A1: Once evaporation is complete, it can only be used to a limited extent to further regulate uniform or deliberately directed cooling. In addition, complete evaporation will not take place. Rather, a water-steam mixture will form, which will be pushed through the channels in a plug-like manner until it condenses in the main channel. Afterwards, water can run into the subchannels, where it forms a water-steam mixture again. There will be some kind of oscillating movement of water and water-steam-mixture. Homogeneous wetting of the cooling surface will therefore not take place. A fluid in different states of aggregation moves back and forth in the channel. Stable cooling will not be achieved.

Furthermore, it is characteristic for channel-like flowed through geometries that these geometries are completely filled with water during the entire process. Due to the constant presence of the cooling fluid, thermal energy is always exchanged with the wall, i.e. the heat exchange cannot be disabled. In previous solutions for near-contour cooling, no options are specified that serve to quickly and completely remove the cooling fluid from the cooling geometry behind the mould rim zone or the near-contour cast-in channel-type cooling inserts. There is also no need to completely remove the cooling fluid from these channel-like flow geometries after a working or process cycle. The flow through the geometries is channel-like and the cooling fluid is pushed further. This also applies to the partially evaporating cooling water in DE 28 50 229 A1, which is a back and forth oscillating water-steam mixture under pressure when cooling is closed. This essentially also applies to the type of discontinuous cooling, in which the cooling fluid in the cooling geometry remains stationary at certain intervals and then moves on, but is not removed from it. Water standing in a discontinuous state runs the risk of adopting a two-phase state that is difficult to regulate for temperature control under the sudden effect of thermal energy, as the cooling surface is close to the contour. Sudden, strong temperature gradients are very likely due to contour proximity. In the case of a cooling system closed to the atmosphere, the sudden temperature increase would be accompanied by a sharp increase in pressure.

Furthermore, in channel-like cooling geometries it is not possible for the cooling or temperature control treatment to take place at a given point of the mould with different options of transferring heat or cooling intensity, because the temperature of the coolant will change increasingly on its way through the channel-like geometry, as well as depending on the time. In general, it will heat up constantly on the way from the entry to the exit. Due to the presence of the channel-like cooling geometry, it is not possible for external heaters to change the temperature or for heating to follow the cooling process, and vice versa, at one and the same location on the tool. If heating and cooling, as for example in DE 741 76 10 U, are arranged locally side by side and locally separated, the cooling medium in the cooling geometry will always be influenced by the incipient heating.

As a result of this lack of possibility to remove the cooling fluid from the channel-like cooling geometries, it is impossible to stop the cooling process in a specific time because the coolant remains in the channel.

Even the heat exchange chamber according to DE 35 02 895 A1 must be supplied and discharged discontinuously with water. As a result, hardly a small part of the water in the heat exchange chamber will evaporate during the casting process and the rest will remain liquid. Instead, all the water in the heat exchange chamber will heat up to the set opening pressure of the outlet valve. If there is no pressure-controlled outlet valve, the water in the heat exchange chamber will remain liquid up to its critical point of approx. 220 bar and 374° C. under strong pressure increase. From this point on, all the water in the heat exchange chamber changes to the vapour state. However, such a pressure increase would be technically difficult to regulate and would not be desired, as the entire water vapour content of the heat exchange chamber would then have to be replaced with liquid cold water. However, it is necessary that continuously or discontinuously cold water flows into and out of the heat exchange chamber. According to DE 35 02 895 A1, this can be achieved up to 240° C., because then the corresponding pressure that the water in the heat exchange chamber assumes seems to be technically justifiable, whereby liquid water is supplied to the heat exchange chamber either continuously or discontinuously and liquid water is discharged. As a result, the system is also flown through in a channel-like manner in accordance with DE 35 02 895 A1, with a continuously filled heat exchange chamber. An exception regarding channel cooling is the cooling proposal made for the first time in EP 0 033 901 A1, or later also in JP000S62130761A, JPS62130762A and WO2015117582A1. By spraying the back of the mould shells with water using injection nozzles, the thermal balance of the mould shell can be influenced to a limited extent. However, this cooling is locally completely inaccurate and therefore only applicable to a limited extent. If a certain area of a vertical hot wall is sprayed with water, the coolant will only ever partially evaporate on the wall.
The larger part will run from this area in a liquid state of aggregation in the direction of gravity. This follows solely from the physical laws of spraying hot walls with water. Therefore, areas located in the direction of running water will come into contact with it and will also be cooled.
A sharp local separation is still not possible, as neighbouring regions are also wetted due to the radial spreading of the water sprayed through the nozzle.
Furthermore, adjacent areas cannot be cooled with different cooling methods or cooling intensities without mutual interference. If some areas of the mould shells have to be treated with different coolants, e.g. some areas with cold compressed air and adjacent areas with splash water, both cooling variants can also be expected to be severely impaired. The effect of compressed air in the form of a free jet on a certain surface of the mould shell would restrict splash water cooling of an adjacent area in its application to the mould shells and their effect. For this reason, the complete possibility of carrying out conflicting types of temperature control in adjacent areas is also missing. Heating and cooling methods cannot be used in adjacent areas. The mutual influence or material and thermal interaction would be too high.
If, for example, there are certain areas on the outer mould shells which have to be heated externally, draining or wide-spreading splash water from neighbouring areas would severely impair this heating or make it completely impossible. It is not possible to prevent such influence during temperature control.

Therefore, a locally different or locally limited temperature control and regulation of the temperature of the surface or rim zone to be temperature-controlled cannot be carried out with the proposed type according to EP 0 0 033 901 A1 or JP000S62130761A and WO2015117582A1.

At present, the risk of critical conditions for the liquid cooling fluid water resulting from various mechanisms of heat transfer is not taken into account. They depend on the temperature of the temperature-controlled wall. This results in a very fast instability of temperature control in the near-contour cooling of moulds. However, this is particularly important in the case of near-contour cooling, since the small distance between the cooling geometry and the cavity means that strong and sudden heat flows can sometimes be expected via the thin, near-contour mould wall onto the cooling system. This can be the case especially with castings made of magnesium or aluminium, if a sudden strong heat flow occurs from the introduced melt.

In the case of water in an open cooling system, uncontrolled formation of steam-water mixtures may occur locally in cooling geometries with a channel-like flow. The intended stable heat transfer to the cooling fluid can be severely impaired. Especially in the other case, the closed cooling system with water as cooling fluid, critical conditions may occur. In this case, a strong increase in pressure in the cooling system must be expected in the event of local overheating, if there are no buffers for expansion. Overheating in a closed cooling system is possible up to the critical point of water and beyond. In the case of the cooling fluid oil, local overheating of the cooling wall can lead to decomposition and the resulting deposits of cracked products of the oil on the hot wall. The originally intended heat transfer is therefore no longer possible.

In addition, it is often not clear whether the revealed solutions for near-contour cooling refer to open or closed cooling. It is noticeable that state-of-the-art tool temperature control systems are revealed that do not take the mechanisms of heat transfer into account. It was obviously not understood that these mechanisms exist in the temperature control of hot walls. The mechanisms separate different areas of heat transfer, or each mechanism is valid in a certain area of the temperature of the wall. In addition, these areas shift when certain variables are changed, such as the surface condition of the wall and those of the cooling method. One such process variable is also the pressure of the system. If the cooling system is closed, i.e. Sealed against the surrounding atmosphere, the cooling system can easily come under pressure. This would happen if the temperature rises rapidly somewhere in the cooling system, e.g. on a near-contour wall. Depending on the current system pressure, the mechanisms of heat transfer and with them the size of the transferable heat per unit of time or the cooling intensity shift.

Therefore, the task of the present invention is to create a method of surface temperature control of the temperature of shell-shaped moulding tools for media communicating with each other in polyhedron-like spaces from the rear of the mould tool.

### SUMMARY

Method for near-contour surface temperature control of shell-shaped moulds (14) with mould rim zones (1), wherein the temperature control of the mould (14) on a near-contour temperature control surface (4) with adjacent, web-like or wall-like separated subareas (4.i) is effected from the respective rear space (3) of the mould rim zones (1) of the mould (14) and/or the respective mould rim zone (1) of the mould (14) and the shell-shaped moulds (14) are designed in two or more parts with the respective mould rim zones (1), characterised in that the temperature control as cooling in the form of temperature control on the temperature control surface (4) is locally different in subareas (4.i) the temperature control surface (4) is effected in accordance with the temperature ranges of convection, bubble evaporation, partial and/or stable film evaporation of the liquid cooling fluid water, wherein the temperature control of the temperature control surface (4) and/or the temperature distribution in the individual subareas (4.i) of the temperature control surface (4) is controlled by means of different temperature control regimes of the subareas (4.i) of the temperature control surface (4) and wherein the temperature control takes place in a rear space (3) open towards the surrounding atmosphere.

### DETAILED DESCRIPTION

The invention is solved with the features of main and secondary claims. The invention has the advantage of making it possible to control the temperature of parts of the temperature control surface of the shell-shaped moulds individually in terms of time, freely selectable in terms of the location. Furthermore, no almost point-shaped or small circular areas are tempered; instead, the temperature of the temperature control surface, which is extended over a large area and close to the contour, is controlled by regulating the temperature of the partial areas that follow the engraving as far as possible. There is no temperature control according to the classical method in channels, no matter what geometric shape. Temperature control is made possible by the possibility of using different temperature control media in an open cooling system, i.e. open under pressure towards the atmosphere. Furthermore, the thermal interaction of the temperature control media with the temperature control surface can be interrupted and continued at any point on the temperature control surface at any time. The temperature or temperature distribution of each part of the temperature control surface of the mould rim zone can be controlled by selectively switching the temperature medium water on and off using various mechanisms of heat transfer. Thus, subsequently changing cooling and heating treatments are possible in the same subarea. This improves planning of the casting process. The protection of the tool is influenced as early as possible. It is possible to influence the mechanical properties of the workpiece or the forming piece in accordance with the technological objectives of the process, for example by influencing porosity and fine grain size, especially in sensitive areas of the workpiece. It is possible to influence the exact mould filling already during planning of the process. The described process effectively counteracts the formation of defect patterns of the workpiece, such as cold running, streaks, etc., which are the result of cold areas of the engraving. The process allows extensive expansion possibilities for the application of thin-wall die-casting. The improved temperature control of the mould minimizes thermal-mechanical stresses and prevents premature cracking on the engraving of the mould. By preventing them, the mechanical stability of the casting moulds can be guaranteed. For the application of release agent to the engraving, no spraying of water/release agent mixtures with the air carrier is necessary any more. Release agent is only applied still to the engraving alone. This minimizes the use of release agents and compressed air. Compared to classical cooling by spraying the engraving with a mixture of separating agents and water, the generation of waste water or its treatment is no longer necessary. Depending on technological requirements, the process only requires the use of an optimal quantity of cooling medium. Only as much cooling medium is required as is specifically required for controlling the temperature of the respective partial area from the back of the mould. Most of the process energy generated during the forming process is dissipated via the rear chamber of the shell-shaped mould and no longer by spraying the engraving with a mixture of separating agent and water, as is the case in the traditional way. As a result of this process, the process time is considerably reduced. In addition, the forged steels previously used in die-casting in particular can still be used in mould making. Essentially, the usual or classic machining tools of mould construction can be used for the production of the invented temperature control surface from the back of the mould. The temperature control surfaces of the shell-shaped moulds used for temperature control can be suitably conditioned in the process for optimum application of cooling in the subareas. The temperature control media can also be conditioned in order to optimally design the temperature control process according to the invention. A reworking of existing or used moulds to the inventive process is possible, provided that the respective geometric requirements of the rear space of this existing mould allow for it.

There are various mechanisms of heat transfer when irrigating a hot wall with water. These mechanisms are the convection on the wall, which changes into bubble evaporation, which in turn changes into film evaporation at the burnout temperature. Film evaporation is divided into partial and stable film evaporation. The boundary between partial and stable film evaporation is the Leidenfrost point with the Leidenfrost temperature. These mechanisms are used in a controlled manner in the process according to the invention. This means that heat can be transferred in a controlled manner at any time and at any location on the temperature control surface. According to the present invention, the temperature of the subareas of the temperature control surface is regulated according to the mechanisms of heat transfer of liquid water to a hot wall, such as convection, bubble evaporation and that of partial and/or stable film evaporation. The temperature and temperature distribution of the sub-areas of the temperature control surface can be controlled differently. The cooling system should be open towards the atmosphere, i.e. open under pressure, and there should always be a pressure equalisation with it. The Leidenfrost temperature or Leidenfrost point of the wall surface plays an important role, which has been known for a long time. At the Leidenfrost point, the mechanism of heat transfer from the water to the hot wall changes. The temperature of the hot wall surface determines the mechanism of heat transfer. This mechanism is used to determine the size of the heat transfer coefficient. It is a measure of the intensity of heat transfer. High coefficients lead to strong heat transfer. If it sinks, heat transfer is accordingly lower. At temperatures higher than the Leidenfrost temperature, heat transfer takes place according to the mechanism of stable film evaporation. The first contact of the water with the surface produces a very thin film of steam on this surface, which prevents further direct contact of the liquid cooling fluid with this hot surface. The steam film insulates heat. As a result, above the Leidenfrost temperature, the dependence of the heat transfer coefficient on the wall temperature is weak. If the surface temperature of the wall drops to the Leidenfrost point, the mechanism of heat transfer changes. The insulating steam film begins to break and direct contact of the liquid water with the hot surface is partly possible. The area of partial or partial film evaporation therefore begins at the Leidenfrost point. The more the temperature of the wall drops, the better the contact of the liquid water with the hot surface and the smaller the areas of the insulating steam film on it. This also increases the potential for heat transfer or the intensity. The heat transfer coefficient increases. The area of partial film evaporation ends at the burnout point with the maximum possible heat transfer. Like the Leidenfrost point, this depends on many factors. Below the temperature of this burnout point, the area of bubble evaporation of the water begins on the hot wall. At high temperatures, many bubbles form on unevenness in the wall. This potential for bubble formation decreases with decreasing temperature. At the same time, the heat transfer coefficient or the intensity of heat transfer to the wall decreases. At low temperature, the bubbles disappear from the wall and the area of convection begins, i.e. the transfer of heat by simply flowing the liquid water to the wall. This convection can be free, i.e. without forced external force or by forced external force of flow of fluid onto wall. These are the mechanisms of heat transfer of liquid water to the hot wall, to which certain areas of the wall temperature are assigned. The heat transfer from the wall to the liquid water is different in all areas.

The Leidenfrost point depends on many variables: sprinkling density or water application density, inflow velocity and type of water inflow, surface material of the wall, composition of the water, system pressure, deposits on the wall, chemical changes of the wall surface, structure of the wall surface, etc.

By controlled use of the mechanisms of heat transfer on a hot wall, the mould can be controlled over different parts of the temperature control surface according to the present invention. In the sub-areas, control is based on setpoint temperature or a setpoint temperature distribution.

The temperature control surface of the shell-shaped moulds is divided into subareas with irregular, polygonal layout plans, which are delimited by wall-like separating and passing elements which are connected to or worked out with the tempering surface. The separating-passing elements define a laterally limited subarea with an irregular, polygonal layout plan in such a way that its inner space is created by mechanical or thermal or similar methods of material processing or the lateral boundaries are worked in or applied by subsequent steps of material processing. Such a layout plan has at least three basic sides on the temperature control surface. Here, the temperature control surface and the subareas limited by the separating-passing elements form a polyhedron-like space, the boundary surfaces of which are the separating-passing elements and the base area on the temperature control surface, and the polyhedron-like space on the side opposite the temperature control surface is open or at least partially bounded by housing parts. These polyhedron-like spaces have different depths due to separation-passing elements of different heights. The faces of the separating-passing elements facing away from the temperature control surface are on different levels.

Only the outer, lateral, wall-like boundary of the respective polyhedron-like space remains. These outer wall-like boundaries are called separating-passing elements in the following. A polyhedron-like space is thus delimited by separating-passing elements. These are located on the temperature control surface with their front surfaces facing the temperature control surface. As the wall-like separating-passing elements are mounted, it is understood that the separating-passing elements are worked in by mechanical processes, such as milling, eroding, etc. from the back of the mould, so that they form a material-locking connection—i.e. without interruption of the material flow of the mould rim zone—non-detachable connection with the mould surface. However, it is also possible to completely finish the mould rim zone from the rear side of the mould using processes such as milling and eroding, etc. close to the contour and then apply the separating-passing elements to the temperature control surface by welding, soldering, screwing, 3-D processes such as selective laser melting or similar. If it is desired that the liquid temperature control medium water does not run over the front surfaces of the separating-passing elements facing the temperature control surface to the temperature control surface in the adjacent polyhedron-like space, the worked out or applied separating-passing elements must be applied to the temperature control surface in a watertight manner against liquid water running.

In both cases, this creates the mould rim zone with the temperature control surface on the back, on which the separating-passing elements, which form polyhedron-like spaces, sit. The rear side of the mould that has been cut out in this way is referred to as the rear chamber or temperature control chamber. It contains the polyhedron-like spaces which are applied or incorporated on the temperature control surface via their separating-passing elements and which, individually or as a group, represent subareas of the temperature control surface.

This is to be regarded as fundamental to the present procedure: The transfer of heat can only be controlled if there are separating-passing elements for the subareas on the temperature control surface. If this were not the case, sprinkling of a location on the temperature control surface would cause the liquid water to run wide and down into other areas of the temperature control surface in a completely uncontrolled manner. However, certain desired areas of the temperature control surface should be sprinkled evenly or wetted with a film in a targeted manner. This is the only way to specifically control the need for cooling intensity or heat dissipation. In principle, almost always liquid water will run away from the place of sprinkling, especially as the temperature control surfaces are in most cases vertical. On the one hand, a certain intensity of sprinkling is used to achieve a cooling effect at all. On the other hand, it is intended that water should evaporate directly at the point of impact, so water could only be applied successively in droplets. To do this, the drop would have to hit a flat horizontal temperature control surface from which no rolling can take place. If the evaporation should take place in the area of the stable film evaporation, then the drop would move in any case unstable on the hot surface, because a steam cushion would be under it. And even if located in the area of the stable film evaporation, the evaporation would not take place immediately. The wall becomes a little colder at the point of impact, which is compensated from the inside by the addition of heat to the surface. It is therefore not possible for the mechanisms of heat transfer to keep the water in one and the same place when spraying the place of the hot wall. If no separating-passing walls are inserted, the water must run uncontrolled wide. The physical mechanism of heat exchange when liquid water hits a hot wall does not allow it otherwise. Therefore, the solution of simple spraying of hot mould walls presented according to JP000S62130761A and EP0033901 A1 cannot lead to an adjustable and controllable transfer of heat at a desired limited destination. The temperature of neighbouring locations is always affected uncontrollably by water spreading out and running down from the spray area. In the areas of bubble evaporation, partial and stable film evaporation, steam and run-off water is always generated from the spray area.

The polyhedron-like spaces or their separation-passing elements can be multifarious. This depends on the conditions and requirements of temperature control.

The base area on the temperature control surface of the polyhedron-like spaces, which are bounded by separating-passing elements, represents the respective sub-areas on the temperature control surface. However, a separating-passing element does not have to be synonymous with a boundary of a subarea. Thus, several polyhedron-like spaces can also belong to a subarea. A subarea serves to delimit a temperature control task on a certain area of the temperature control surface. It controls a preset setpoint temperature or a temperature distribution. Additional separating-passing elements can be applied or incorporated in this. Other requirements for the application of separating-passing elements are, for example, the targeted conduction of flows of the temperature control medium. For example, it is often advisable to design the separating-passing elements in such a way that temperature control with temperature control media is only possible on the temperature control surface. This means that the separating-passing elements often do not have a flat shape, but rather have to be curved and additionally arranged on the temperature control surface.

Further requirements for the application of separating-passing elements is the mechanical stability of the tool or the mould rim zone. This often requires additional separating-passing elements. Individual polyhedron-like spaces on the temperature control surface can therefore represent subareas of the temperature control surface. However, several polyhedron-like spaces can also be part of the temperature control surface.

The subareas of the temperature control surface represent extensive areas of the temperature control surface, whose size and geometry as well as the number of separating-passing elements change greatly. The number of polyhedron-like spaces does not have to be equal to the number of subareas.

This subdivision of the entire temperature control surface with separating-passing elements enables the complete wetting or flow of temperature control media and thus the control of the temperature of individual subareas.

Suitable heat transfer is only possible in the individual subareas by the suitable selection of the number and appearance of the separating-passing elements. It is a prerequisite for the optimal functioning of the process according to the invention. This subdivision depends on the given requirements for temperature control of the temperature control surface and especially on the requirements for temperature control of the workpiece or heat transfer from the workpiece to be formed.

Furthermore, this subdivision depends on the stability of the mould rim zone, which must meet the mechanical safety requirements for the tool. The separating-passing elements thus ensure the mechanical stability of the mould rim zone. The forces occurring during the casting process are passed on to the solid area of the mould via the separating-passing elements or polyhedron-like spaces.

Every polyhedron-like space still has open access to the atmosphere. This means that these subareas are open to the atmosphere or have almost the same pressure to the atmosphere. In other words, the pressure of the temperature control fluids used to control the temperature of parts of the temperature control surface is equal to or almost equal to the pressure of the surrounding atmosphere. The pressure in the temperature control room does not exceed or is almost equal to the prevailing external ambient pressure.

This is generally the normal atmospheric pressure of 1 bar. The whole system of temperature control is open to the surrounding atmosphere. The process is not operated at a pressure higher than that of the normal atmosphere. When cooling the temperature control surface with liquid water, the maximum temperature of liquid water on the hot temperature control surface is approx. 100° C. under normal conditions. At this temperature, liquid water turns into steam under normal ambient pressure.

The separating-passing elements can be flat or different in type, allowing a partial mutual influence of the fluid temperature control media between the individual polyhedron-like spaces on the temperature control surface. This makes it possible for fluid temperature control media of one polyhedron-like space to partially pass into an adjacent polyhedron-like space and to partially mix or interact with each other in the corresponding polyhedron-like spaces. The media of different polyhedron-like spaces can therefore communicate with each other. Since the polyhedron-like spaces continue to have connection to the surrounding atmosphere, which will usually be air, air can also have access to the polyhedron-like spaces. The communication of media from adjacent polyhedron-like spaces can be achieved by the separating-passing elements between the polyhedron-like spaces having interruptions and thus allowing a mixture of both fluids. The separating-passing elements do not have to sit completely on the lower front side of the temperature control surface. On the other hand, separating-passing elements can sit completely on the temperature control surface but have such a height that partial mixing of fluids from adjacent polyhedron-like spaces or even more distant polyhedron-like spaces of the temperature control surface is possible. Furthermore, separating-passing elements of adjacent polyhedron-like spaces may otherwise have openings to allow partial exchange of fluids from adjacent polyhedron spaces. However, it may be desired from the outset that several wall-like separating-passing elements are simultaneously overflowed or oversprinkled by one and the same temperature control fluid. This can be done from the outside by adding the fluid for temperature control purposes or for the purpose of guiding the fluid flow. With fluid communication between polyhedron-like spaces, it is thus possible for fluids to reach areas of the respective subarea of the temperature control surface or the end surfaces of the respective polyhedron-like spaces that are difficult to access geometrically. This is important because the highly variable geometry of the near-contour temperature control surface in the partial areas will always have corners and edges that are difficult to achieve without the possibility of adapted fluid flow control, i.e. a targeted direction of the flow. In the case of liquid water, it is important that a liquid film is distributed on the temperature control surface or on a part of it in order to transfer heat in a controlled and regulated manner at all times, according to the mechanisms of heat transfer, convection, bubble evaporation and partial and stable film evaporation. In the case of stable film evaporation, a thin layer of steam forms between the hot surface and the liquid water when sprinkling with water. If such a liquid film is not on the respective part of the temperature control surface, the controlled heat transfer is not possible.

The wall-like separating-passing elements do not have to be of flat shape. This means that they do not have to be worked into the temperature control surface as a classical geometric plane with the respective machining process, such as milling or similar, or applied to it, such as welding or similar, but can be of any shape, e.g. also wavy or convex. This may be necessary due to the technological requirements of temperature control or other requirements of the mould rim zone. Due to the suitable geometric design of the separating-passing elements, however, it is possible to carry out different temperature control in adjacent subareas of the temperature control surface and to minimize the interaction of the media via the separating-passing elements of the polyhedron-like spaces. The separating-passing elements also contribute to the mechanical stability of the mould rim zones. In addition to their ability to separate and allow fluids to pass through, they are also designed with regard to the stability of the mould rim zones. The separating-passing elements thus ensure the mechanical stability of the mould rim zone.

### BRIEF DESCRIPTION OF THE DRAWINGS

Several drawings, in which essential features of the invention are presented, are described in more detail below. They display the following:

FIG. 1 shows a schematic sketch for designing a flat-type near-contour, shell-shaped mould for media communicating with each other in polyhedron-like spaces as a sectional view of a closed mould with two halves of the mould, each with the rim zones of the mould,

FIG. 2 shows a schematic sketch for the design of a flat-type, near-contour, shell-shaped mould for media communicating with each other in polyhedron-like spaces as a sectional view of a closed mould with two halves of the mould, each with partial areas of the temperature control surfaces on the mould rim zones,

FIG. 3 shows a top view of the temperature control surface of a mould rim zone with partial areas and separating-passing elements,

FIG. 4 shows a schematic of a possible control of the temperature of a subarea of the temperature control surface,

FIG. 5 shows a diagram of a discontinuous activation of the sprinkling volume flow in bar graph,

FIG. 6 shows a diagram of the continuous heating of a part of the temperature control surface in bar graph,

FIG. 7A shows a basic curve of the heat transfer coefficient α as a function of the wall temperature [symbol] ₒ of the temperature control surface when sprinkling with water,

FIG. 7B shows two selected setpoint temperatures to be controlled on the temperature control surface with the corresponding heat or cooling intensity to be transferred,

FIG. 8A shows a displacement of the areas of heat transfer when the surface material of the temperature control surface changes due to a desired chemical change or physical coating,

FIG. 8B shows a displacement of the areas of heat transfer when the surface material of the temperature control surface changes due to an unwanted chemical and/or micro-mechanical change in the surface of the wall material,

FIG. 9A shows a sectional view of a separating-passing element, incorporated in a mould shell,

FIG. 9B shows a side view of FIG. 9A of a separating-passing element, incorporated in a mould shell,

FIG. 10 shows a cross-section through the mould shell with separating-passing elements and sprinkling nozzles applied to the mould shell,

FIG. 11A shows the sprinkling by means of a sprinkling nozzle of an area that is difficult to overflow on a part of the temperature control surface,

FIG. 11B shows the side view of FIG. 11A,

FIG. 12 shows the representation of the change in the heat transfer of the temperature control surface due to its ageing and the associated change in the control of the setpoint temperature of the temperature control surface and

FIG. 13 shows an orientation option for a controller in the areas of heat transfer.

### DETAILED DESCRIPTION OF THE PREFERRED EMBODIMENTS

According to the invention, the new process is used to temperature-control the back surfaces of shell-shaped moulds 14 with mould rim zones 1. These rear surfaces are called temperature control surfaces 4. The temperature control surface 4 is divided into different subareas 4.i. The mould 14 can be two-part or multi-part and thus have several mould rim zones 1, which are temperature-controlled according to this present process. The respective temperature control surface 4 of the mould rim zone 1 can be designed so that it follows the engraving 5 of cavity 2 of mould 14.

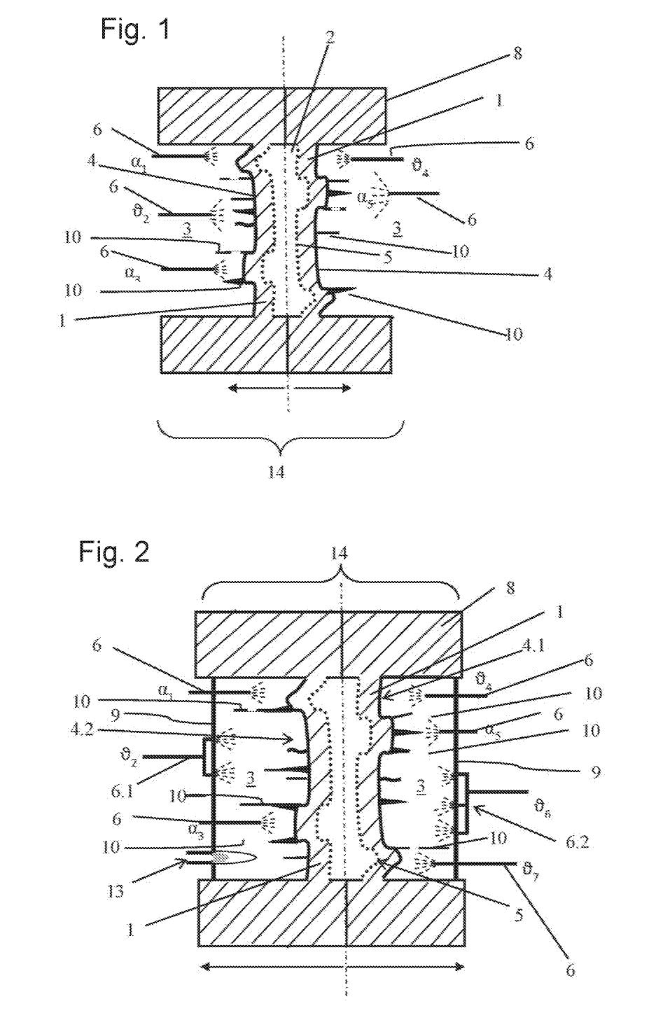

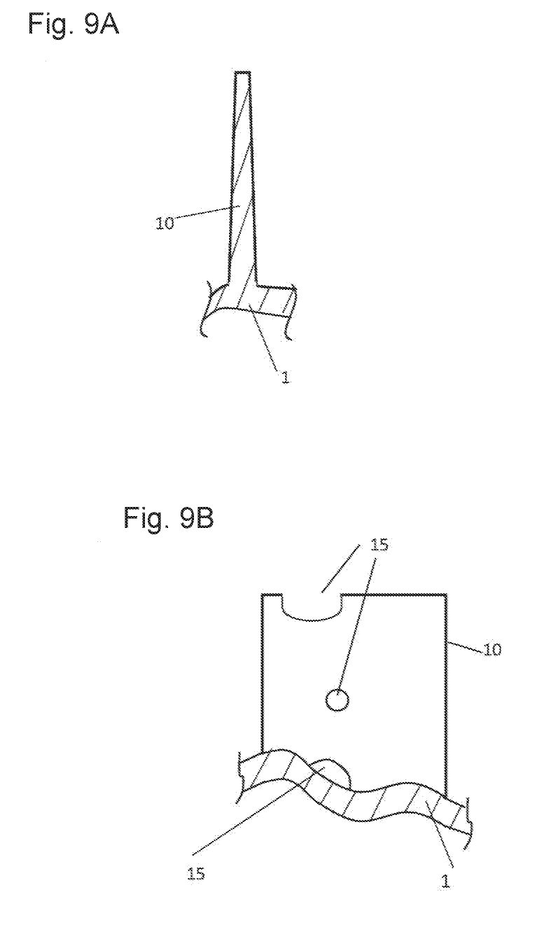

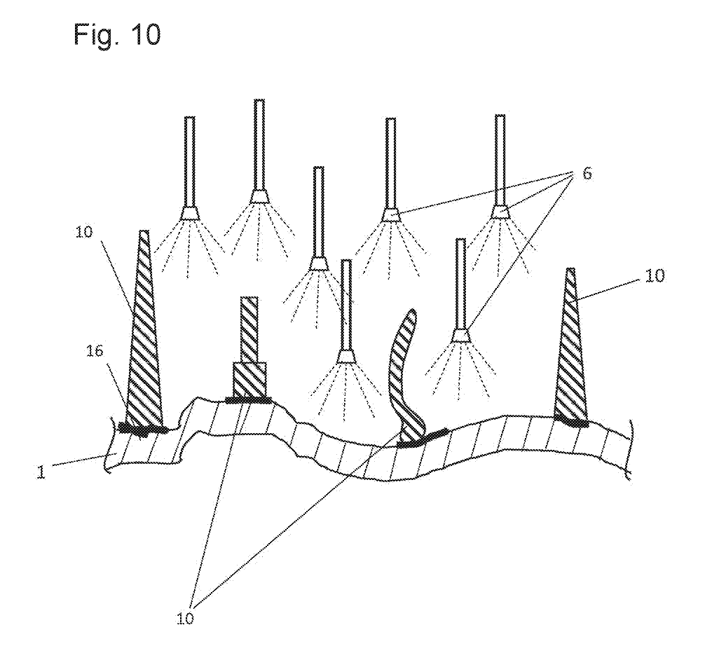

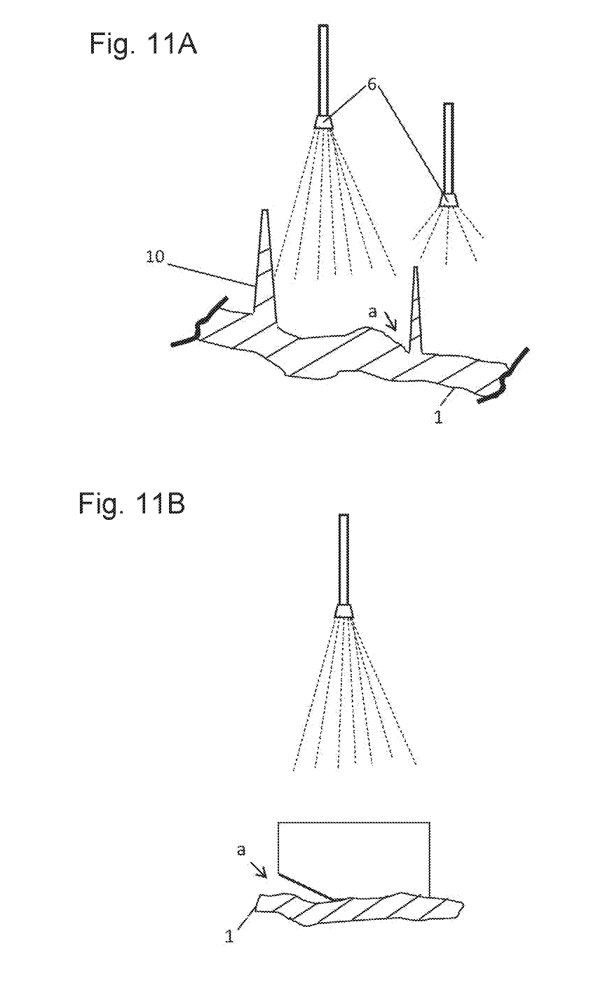

The temperature control surface 4 can be cooled or heated. In principle, the temperature can be controlled by various media in subareas 4.i and their polyhedron-like spaces in the rear chamber 3 of the mould. In FIGS. 1 and 2 this is shown schematically in a sectional view through form tool 14. The temperature control media in the polyhedron-like spaces can communicate with each other via separation-passing elements 10. Depending on the requirements of temperature control and flow control, the individual separating-passing elements 10 are worked into or applied to the temperature control surface 4. This makes it possible to achieve optimum temperature control of the entire temperature control surface. FIGS. 9, 10 and 11 show examples of such separating-passing elements. They are wall-like structures that are flat or wavy, depending on the requirements. For example, they are also dome-shaped in one part or have break-outs 15. They are then adapted in their shape to meet the requirements of the interaction of the temperature control media in neighbouring polyhedron-like spaces. In addition, the separating-passing elements 10 have a discontinuous cross-section, so that on the one hand the distribution and drainage of the water is more reliable and on the other hand the stability is improved. Schematic illustrations are shown in FIGS. 1, 2, 9, 10 and 11A as examples. If, for example, a subarea 4.i of the temperature control surface 4 is overflowed with liquid water, it must be ensured that the entire subarea 4.i is wetted by a water film which is constantly renewed by sprinkling with the cooling medium water in order to make the heat transfer always reproducible in this subarea 4.i. For this purpose, the water must also reach corners and edges on the temperature control surface 4 of the respective subarea. Due to the strongly changing topography of a surface close to the contour, this is often difficult to achieve with walls that resemble a plane. Therefore, the shape of the respective wall-like separating-passing elements 10 must be adapted in such a way that a suitable overflow of water can take place over the entire subarea 4.i. Without water film, this process cannot be carried out according to the mechanisms of heat transfer of liquid water to a hot wall, convection, bubble evaporation, stable and partial film evaporation. Furthermore, the separating-passing elements 10 are of different heights. They are also sprinkled with liquid water or generally by the temperature control fluid during sprinkling, provided this is favourable for overflowing the respective subarea 4.i of the temperature control surface 4. FIG. 10 shows the separating-passing elements 10 applied to the temperature control surface 4 by welding. The separating-passing elements 10 are also provided with openings 15 to ensure an interaction of the media in adjacent polyhedron-like spaces. This is exemplified in FIGS. 9A, 9B and 11A, 11B. In addition to ensuring a good overflow of the temperature control fluid, the separating-passing elements 10 also ensure the stability of the mould rim zone 1. They have a suitable shape and are arranged in a suitable shape on the temperature control surface 4. Accordingly, the separating-passing elements 10 are wall-like structures whose shape and number are specially adapted to their tasks on the temperature control surface 4.

If the incorporated or applied separating-passing elements 10 are only used for the mechanical stabilization of the mould shell 1 and/or the conduction of fluids on the mould shell 1, these do not necessarily extend directly to the temperature control surface 4 of the mould shell 1. Depending on the requirements, the separating-passing elements 10 have different heights in order to ensure optimum mechanical stability and/or flow channeling.

As shown in FIG. 2, the rear chamber or temperature chamber 3 can be closed with a housing part, such as an end plate 9, depending on requirements. Devices for temperature control and delimitation of the temperature control surface 4 can be advantageously integrated into the end plate 9, insofar as this is technologically or geometrically advantageous. The end plate 9 can be used to guide and secure supply and return lines for operating the temperature control devices for the temperature control surface 4, as well as supply lines for the sensors. The end plate 9 is made of the same mould material, but can also be made of a different material. It can be made of metal. Depending on the design of the mould 14, the end plate 9 can have a load-bearing or non-load-bearing function. Accordingly, it absorbs forces of the working or forming process. The end plate 9 of the temperature control space 3 can also have the form of an end box. The advantage here is that, in addition to fixing the supply lines and devices for temperature control, the cooling water that accumulates can be well collected and passed on. This end box does not necessarily have to be fixed rigidly in the rear of the mould. However, the end plate 9 must not be in the way of opening the temperature control space 3 to the atmosphere. In the present process there is always a pressure equalisation of the polyhedron-like spaces with the atmosphere. Separating-passing elements 10 can also be arranged on the end plate 9, from where they extend to the temperature control surface 4. According to a specific requirement, the separating-passing elements 10 have direct contact with the temperature control surface 4.

The additional part of mould 14, next to mould rim zone 1 and temperature chamber 3, is the solid area 8 of mould 14. Forces of the working or forming process are transferred to the solid area 8 via the mould rim zones 1 and the polyhedron-like spaces with their separating-passing elements 10 located on them.

Various temperature control media can be used for cooling or temperature control of the shell-shaped moulds 14. It is known that for the intensity of cooling of a hot wall with liquid water the heat transfer coefficient α depends on the surface temperature [symbol] ₒ of the wall. When cooling a mould 14 with liquid water, the heat transfer in this case is strongly dependent on the temperature [symbol] ₒ of the temperature control surface 4 or subareas 4.i of the temperature control surface 4. Therefore, the transfer of heat or the cooling intensity can be varied or specifically controlled according to the temperature of the temperature control surface 4 by means of devices for temperature control of the temperature control surface 4.

When sprinkling a hot wall with water above the burnout temperature [symbol] _{Bo} there are basically two mechanisms of heat transfer to the wall. The Leidenfrost temperature or Leidenfrost point of the wall surface plays an important role here, something that has been known for a long time.

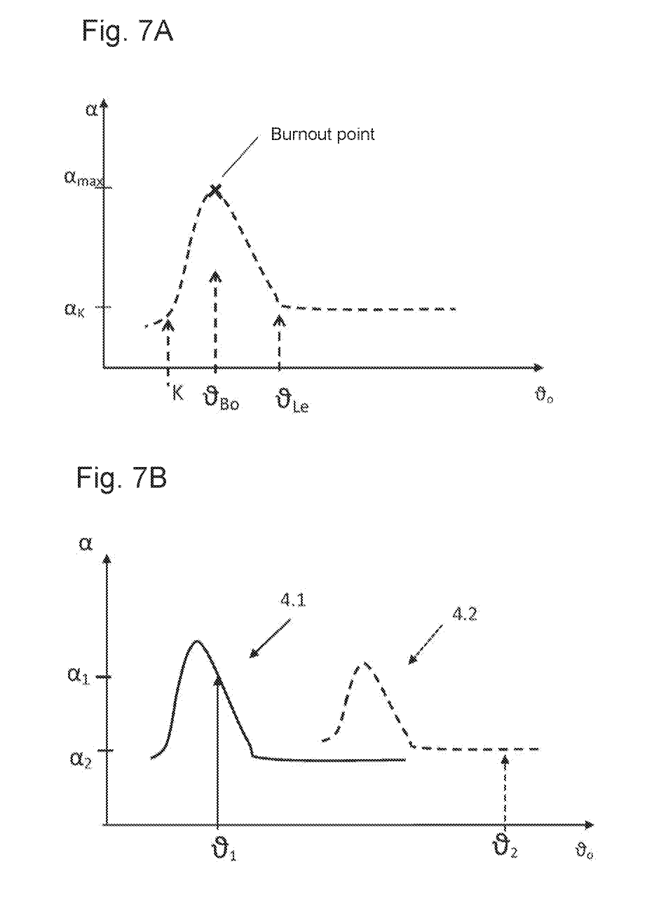

FIG. 7A shows the principle curve of the heat transfer coefficient α from the wall temperature [symbol] ₒ. The burnout temperature [symbol] _{Bo} and the Leidenfrost temperature [symbol] _{Le} are shown. From the burnout temperature [symbol] _{Bo} to the Leidenfrost temperature [symbol] _{Le} [symbol] [symbol] the area of partial film evaporation is limited. The heat transfer coefficient rises sharply from the Leidenfrost temperature [symbol] _{Le} [symbol] a with falling wall temperature and is at a maximum at the burnout temperature [symbol] _{Bo}. With the heat transfer coefficient αₘₐₓ above the Leidenfrost temperature [symbol] _{Le} the area of stable film evaporation begins. Above the Leidenfrost temperature [symbol] _{Le} the heat transfer coefficient α increases only slightly with the temperature, it is almost constant. With the heat transfer coefficient α. below the burnout temperature [symbol] _{Bo} the area of bubble evaporation of the water on the hot wall begins. If bubble formation on the wall ends at point K, the area of convection of the water on the wall begins.

In the present invention, all phenomena of heat transfer of water on the hot wall can be used for temperature control of sub-areas 4.i of the temperature control surface 4 with liquid cooling fluid water, namely the areas of stable film evaporation and partial film evaporation at high wall temperature [symbol] ₒ up to burnout temperature [symbol] _{Bo}. At temperatures lower than the burnout temperature [symbol] _{Bo}, the areas of bubble evaporation and convection are used. For example, in section 4.1 of the temperature control surface 4 at temperature [symbol] , in section 4.2 at temperature [symbol] and in section 4.3 temperature control can be done at a further temperature [symbol] . In these cases other heat can be transferred per unit of time or heat intensity, which can be read, for example, from the associated heat transfer coefficients α₁ and α₂ in FIG. 7B. In principle, it is therefore possible to transfer different types of heat in different subareas 4.i and at different times using the various mechanisms of heat transfer.

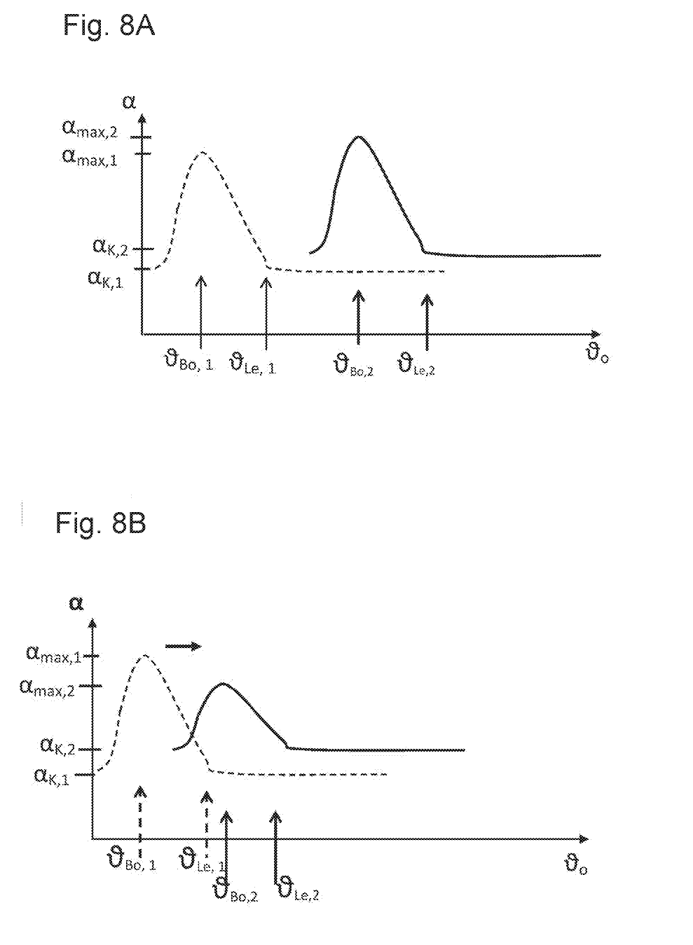

The variables or dependencies of the Leidenfrost point on these variables can be used for cooling or temperature control with the liquid cooling fluid water in a targeted manner. For this purpose, the areas of heat transfer on the temperature control surface 4 and thus the intensity of heat transfer or the heat transfer coefficient can be shifted into a temperature range that is favourable for the process in a targeted manner. For example, the surface of the material of the temperature control surface 4, which can be specifically modified, plays a special role for the Leidenfrost point. The surface can be changed chemically, for example by surface oxidation or similar and physically, for example by evaporation with a substance. As the surface material changes, the interaction of the water with the hot surface and thus the Leidenfrost point and the areas of heat transfer change. This is shown in principle in FIG. 8A. A surface treatment of the temperature control surface 4 or parts of 4.i shifts the heat transfer from the dotted line type to the type with a continuous line with the respective changing heat transfer coefficients α and the corresponding wall temperatures [symbol] ₒ.

However, there may also be unwanted changes, e.g. chemical changes and changes in the topography of the wall surface. These can be summarized under the term “ageing” of the material and in some cases are difficult to calculate. They occur with increasing service life of the tools. These include, for example, corrosion and associated fracturing and washing out in the microscopic range. They occur as a result of the continuous sprinkling cycles of the hot temperature control surface 4 with cold water. Due to ageing, the interaction of the cooling fluid water with the wall or the temperature control surface 4 also changes. This changes the Leidenfrost point and with it the areas of heat transfer. In FIG. 8B, the consequences of the ageing of the surface have been made visible in principle by way of example. The initial surface with [symbol] _{Bo, 1} and [symbol] _{Le, 1} and associated heat transfer coefficients α_{k,1} and α_{max,1} changes into the surface with the [symbol] _{Bo, 2} and [symbol] _{Le, 2} and associated heat transfer coefficients α_{k,2} and α_{max,2} under ageing.

The interaction of the water with the hot temperature control surface 4 can also be mechanically influenced, for example by structuring the surface with different cutters. This changes the conditions of the surface's wetting with water. As a result, the Leidenfrost point and the associated areas of heat transfer change.

In the temperature range of partial film evaporation, more intensive and also variable cooling is possible compared to that of stable film evaporation, depending on the temperature [symbol] of the wall. In contrast to the area of stable film evaporation, where the transferable heat changes only slightly with the temperature [symbol] of the wall surface, different heat can be transferred in the temperature range of partial film evaporation depending on the temperature [symbol] of the surface of the subarea of the temperature control surface 4.i. In the area of stable film evaporation, the transferred heat is usually almost constant and independent of the surface temperature [symbol] , because the steam film formed prevents this. This can also be used in a targeted manner. The control mechanism can be somewhat slower here due to the low temperature dependence.

There are various temperature control options. If the temperature control surface 4 is cooled with liquid cooling fluid water, sprinkling nozzles 6 are used for its area distribution in accordance with the invention. This invention is a sprinkling cooling system. The sprinkling nozzle 6 is a two-dimensional sprinkling device for liquid cooling fluid water, without using a carrier gas for the cooling fluid. It is characteristic that through the sprinkling nozzle 6 liquid cooling fluid splits water into drops and distributes it in the surrounding gas, which is generally air. The drop size generated via sprinkling nozzle 6 depends on the operating parameters water pressure and water temperature and on the geometry of the sprinkling nozzle 6. The way the nozzle is operated also affects the areas of heat transfer. The basic geometric shape of the drop collective created by the sprinkling nozzle 6 is a drop, sprinkling or spray cone. It is important that the droplets of the spray cone are distributed over the area of the incident geometry of the temperature control surface 4 so that they form a uniform continuous liquid film on it, independent of the respective mechanism of heat transfer. Due to the geometric design of the sprinkling nozzle 6, the distribution can be varied from the geometric shape of a sprinkling cone. On a flat temperature control surface 4 the drops of the sprinkling cone would be scattered, e.g. in the form of a circular disc or an ellipse. Depending on the design of the sprinkling nozzle 6, other geometric forms of sprinkling are also possible. In any case, the temperature control surface 4 of the mould rim zone 1 is wetted over the entire surface with the drop collective of the sprinkling nozzle 6. By selecting the operating parameters of the sprinkling nozzle 6 or by its geometric shape, the sprinkling density or water impact density can be set on the temperature control surface 4 of the mould rim zone 1. Sprinkling density is the amount of water applied to the surface per unit area and time. The density of water impact can influence the Leidenfrost point and the associated areas of heat transfer. The design of sprinkling with the liquid cooling fluid water depends on the conditions and requirements of the sprinkling of the temperature control surface 4 or subarea 4.i of the temperature control surface 4. For example, several sprinkling nozzles 6 can be integrated in an end plate 9 or another mounting device and used for sprinkling.

If, for example, water and sprinkling of the temperature control surface 4 are to be controlled by this water in order to use the mentioned mechanisms of heat transfer, the vertical alignment of the temperature control surface 4, and thus of the tool itself, is required. The water must be able to drain off after sprinkling of the hot temperature control surface 4 or section 4.i in order to interrupt the heat transfer. For this purpose, the separating-passing elements 10 are designed accordingly, so that the cooling fluid water can flow off without any problems.

However, modifications may also occur if the vertical alignment of subarea 4.i is not possible, for example the rapid extraction of water accumulations in cavities of horizontally aligned cores of the tool is also possible and, if applicable, necessary. Important for the present process is the wetting of the temperature control surface 4 with a water film, which must be continuously renewed in order to make the intended optimal heat transfer reproducible according to the mentioned heat transfer mechanisms, such as partial film evaporation and the other mentioned heat transfer mechanisms.

By controlling the temperature [symbol] of the temperature control surface 4, the local cooling intensity or the local transfer of heat to the mould rim zone 1 is influenced. The temperature [symbol] of the temperature control surface 4 has the largest influence on the transmission of cooling capacity. This means that the heat transfer coefficient α and thus the intensity and time of the heat transfer are specifically influenced by the control to the target temperature of the surface of the subarea 4.i. If the surface is adjusted to the target temperature [symbol] ₁ in a subarea 4.i+1, more heat can be transferred in the same time than if [symbol] ₂ is adjusted to the surface temperature in a subarea 4.i+1, see FIG. 7B. This means that the cooling of the workpiece can be controlled specifically via the temperature control of the subarea surfaces 4.i of the temperature control surface 4. In other words, the heat flow from the workpiece to the engraving can be controlled specifically via the temperature control of the subarea surfaces 4.i of the temperature control surface 4. Due to the required contour proximity of the present method, the time required for the effect of the heat flows in the individual subareas 4.i is short compared to conventional methods. In conventional moulds, large material thicknesses of the tool would have to be overcome and thus long times for the effect of the control described would have to be taken into account. These long times are generally not available in the production of castings. In addition, considerable transverse conduction of the heat in the tool would have to be expected, which would call into question or make impossible the locally limited transfer of heat. In addition, the heat transfer via the effect on the heat transfer coefficient α of the subarea has a large scope in the present procedure. If, for example, the material properties in a certain subarea 4.i do not meet the technological requirements, the heat transfer in that subarea can be adapted. This ensures that a tool can be run with different parameters, even after production, and can be adjusted to different requirements for the part or workpiece. The new production of the mould itself is not necessary.

This concerns, among other things, the difficult filling of thin walls on large workpieces, such as structural components, which can often be difficult to influence from the design aspect in advance. The change in the grain size of some areas of the workpiece can also be influenced by changing the heat flow.

The separating-passing elements 10 of the polyhedron-like spaces also enable an almost continuous transfer of heat between the polyhedron-like spaces at the desired points on the temperature control surface, thus avoiding abrupt transition behaviour of the temperature control at the separating-passing elements 10. This is possible by designing the interaction of the temperature control medium water between the adjacent polyhedron-like spaces or via their separating-passing elements 10. The interaction of the media between the polyhedron-like spaces can be designed within wide limits by means of openings 15 or heights of the individual separating-passing elements 10 or intentional overflow of separating-passing elements.

The interaction of the temperature control medium with the subarea surface 4.i can be stopped at any time. If this is desired, the heat transfer can be interrupted almost instantly. By switching the temperature control medium on or off, the thermal interaction with the temperature control surface 4 is started or interrupted in a targeted manner. For example, the water is shut off from the nozzle and runs off immediately from the temperature control surface 4, or a subarea 4.i, and the correspondingly designed separating-passing elements 10.

The possibility of different temperature controls in each subarea 4.i also means that different types of media can be used. The prerequisite is the setting of the corresponding interaction of the media in adjacent polyhedral rooms. If, for example, air is used in a partial area for temperature control and liquid water in an adjacent area, the interaction of the media in adjacent polyhedron-like spaces should be reduced. This is possible by designing the corresponding separating-passing elements 10. Important is the good wetting of the temperature control surface 4 in the case of the medium water and the good flow control in both cases.

Good flow control in the respective subarea 4.i is often only possible via suitable opening of the separating-passing elements 10. Because of the very changeable topography and geometry of the temperature control surface 4, a general solution for flow control of the temperature control fluids is not possible. Furthermore, the separating-passing elements 10 are variable in a wide range, but edges and corners in the area of the seating of the front side of the separating-passing elements 10 on the temperature control surface 4 are sometimes unavoidable. In order to form an even water film or to achieve an even wetting of the surface with water, the partial opening of the separating-passing elements 10 is necessary. FIG. 11 shows an example of the necessity of opening the separating-passing element at its end face to the temperature control surface 4 in an area a which is difficult to overflow. Due to the strongly changing topography, i.e. the geometrically strong change in the height of the surface in the narrowly limited area a of the temperature control surface, overflow in this area a or flow control on the temperature control surface in area a by means of sprinkling cooling is very difficult. For this reason, a small limited gap is worked into the front side of the separating-passing element, thus ensuring good overflow in area a. Wetting with a water film is now also possible in this area a. This is necessary because in the case of temperature control of subarea 4.i with water, all areas of the surface of subarea 4.i must be overflowed with a water film, as this is the only way to ensure the controlled heat transfer of water to the hot wall. The design of the temperature control surface 4 with suitable separating-passing elements 10 is therefore very important for this process. It is not absolutely necessary to provide the separating-passing element 10 in an area with a breakthrough, for example. A streamlined design of the separating-passing element 10, for example the spherical bulging in the area of the end faces facing the temperature control surface 4, can also lead to the same goal as shown as an example in FIG. 10 with the second separating-passing element 10 shown from the right. In the case of temperature control or cooling with water, it is a prerequisite for the transfer of heat in accordance with the various mechanisms of heat transfer.

The purpose of the flow control is to ensure uniform wetting of the respective subarea of the temperature control surface 4.i, whereby the resulting liquid film must be continuously replaced by the sprinkling in order to make the heat transfer reproducible. If not wetted everywhere, or if the water film cannot renew itself continuously, this heat transfer by means of water cannot take place in the non-wetted area. The heat transfer would not be reproducible or not possible or insufficiently possible in areas which are difficult to access or not accessible to the flow.

Changing temperature control with different temperature control media on one and the same subarea 4.i is also possible: Thus, it can be tempered or cooled first with a gaseous medium and then with liquid water. This is made possible by the option of shutting down the respective temperature control medium: After shut-down, it no longer interacts with the temperature control surface of the respective sub-area, because it is no longer there due to shut-down. Water flows off the vertical temperature control surface 4 or subarea 4.i instantly. If a device for the supply of another medium is installed, e.g. for gaseous media, then this can subsequently be used for the same subarea.

In principle, solid media such as ice and mixtures of solid and liquid media such as ice water or solid and gaseous media such as dry ice air are also suitable for cooling and are used for this purpose. However, care must be taken to ensure that the temperature control surface 4 is not inadvertently chemically modified, coated or added and stable temperature control is thus prevented. Furthermore, it is possible with solid temperature control media that these also remain on the temperature control surface after the medium has been switched off, thus allowing a further interaction with it for a limited period of time.

Heat pipes or two-phase thermal siphons, can also be used for the temperature control of sections 4.i of the temperature control surface 4. They must be arranged in such a way that they can interact thermally with sub-area 4.i of the temperature control surface 4 in their characteristic manner. Cooling by means of the aforementioned heat pipes is—due to the connection based on the design—regarded as contact temperature control, whereby with an appropriate arrangement the contact temperature control also has the function of fluid cooling. In principle, electrical devices such as Peltier elements or others can also be used for contact cooling of the temperature control surface 4 or parts of 4.i. They are brought into solid contact with the respective area of the temperature control surface 4.

External heating via the temperature control surface 4 of the mould rim zone 1 or of subareas 4.i of the mould rim zone 1 is achieved by introducing external thermal energy via external heating media 13. Heating can be realised via radiation, flow or contact with external heating media. By the suitable arrangement of heating media 13, such as burners, blowers, radiators or electric heating elements on, in, and below the temperature control surface 4, parts of the temperature control surfaces 4 of the mould rim zones 1 are heated externally from the rear chamber 3 of the mould 14. For example, burners with suitable output and at a suitable distance behind the temperature control surface 4 are positioned. Electrical heating elements can be arranged directly under, on and in front of the temperature control surface 4 of a corresponding section 4.i of the temperature control surface 4. External heating of subareas 4.i is advantageous, for example, in the case of processing thermoplastic materials in injection moulding, in order to be able to machine the workpiece. The external heating from the rear space 3 of the mould rim zone 1 represents a uniform heating of the temperature control surface 4 or of partial areas 4.i of the temperature control surface 4. In addition, there is another advantage of the present procedure: It can be tempered independently of the process cycle of the forming of the workpiece, i.e. also during the opening times of the mould and during the removal of the workpiece. Even before, during or after filling cavity 2, it is possible that a separate temperature control regime runs in various subareas 4.i of the temperature control surface 4 in order to influence the required target conditions. The temperature control regime is understood in such a way that thermal energy can be transferred to the temperature control surface 4 in different intensities depending on the time: This allows external heating or cooling with the technologically required intensity. The sequence of the thermal treatment steps of the mould rim zone 1 is adjustable according to technological requirements. The necessary devices for heat transfer shall be arranged for this purpose.

Depending on technological requirements, for example to adjust certain material properties of the casting, different temperature control regimes of cooling and heating according to the invention can be carried out in the subareas 4.i of the temperature control surface 4. For this purpose, the criteria for the necessity of controlling the temperature control devices can already be clearly defined at the design stage. This significantly increases the ability to plan the process, as it enables simulations, for example, to be carried out in advance.

The temperature control regime or the control to certain temperatures of the subareas of the temperature control surface 4 can in principle be changed from process cycle to process cycle. The different temperature control options in subareas 4.i therefore also make it possible to optimize the temperature control of the entire mould rim zone 1 to different desired thermal target states of the mould rime zone 1 or to control the transfer of the cooling intensity or heat from the workpiece via the engraving to the temperature control surface 4 of the mould rim zone 1. Due to the possibility of realizing different temperature controls or temperature control regimes, the way to optimal cast parts can be found cost-effectively by means of previous simulations, while protecting the mould 14, at minimum process time.

Finally, the temperature control conditions can still be further adjusted in the practical running-in of the new mould 14 so that optimum casting and solidification conditions for the casting can be achieved. For example, the setpoint temperature can be changed in a subarea 4.i of the temperature control surface 4. When cooling with liquid water and, e.g. in the area of partial film evaporation, the intensity or the heat transfer coefficient also changes due to the change in the target temperature for the subarea. Due to the intensity or the transferred heat per time, the time for setting the setpoint temperature changes in subarea 4.i. With the process according to the invention, it is therefore possible to exert variable influence on the mould tool 14 and the workpiece or the moulding while the practical casting operation is still in progress.

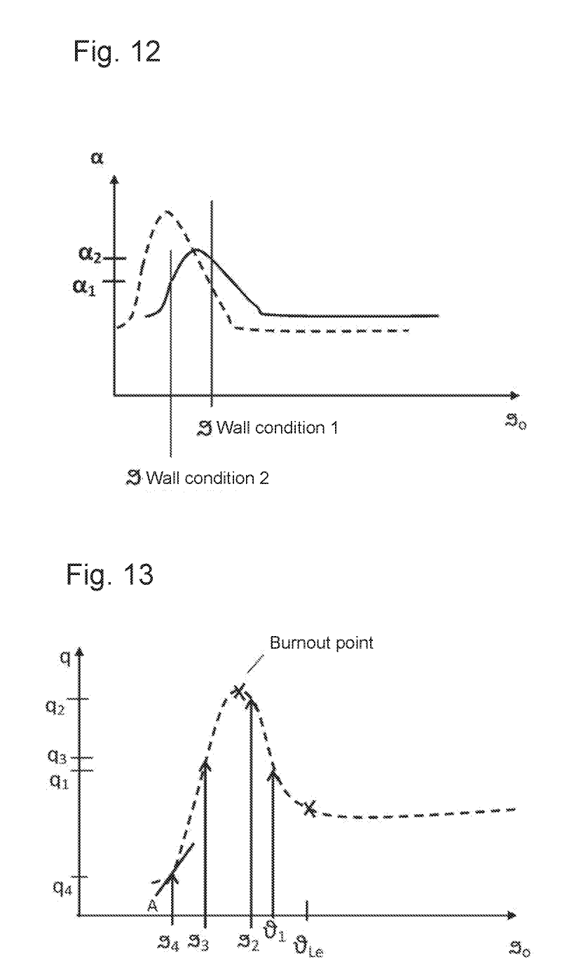

This is of special importance: In the case of the tool steels currently used for casting moulds, constant contact of the temperature control surface 4 with cold water caused by the process is to be expected in the course of operation, if no precautions have been taken against ageing, such as a coating or similar. It is therefore possible to counteract the ageing of this surface by changing the selection of the desired surface temperature of the subarea 4.i. Thus, only the time dependence for the heat transfer (intensity) of the changed surface is to be known and the temperature control of the temperature control surface in subarea 4.i or several subareas 4.i is to be adjusted accordingly. This is shown symbolically in FIG. 12: The dashed curve symbolizes the initial surface of section 4.i of the temperature control surface 4. It is moved to the right due to ageing. This means that the Leidenfrost point and the areas of heat transfer shift to higher wall temperatures. If the temperature controller would continue to operate at the same setpoint temperature [symbol] _{Wall condition 1} of the subarea, the different heat transfer coefficients α would extract much more heat from the wall per unit of time. This means that the aged wall would cool down faster because at the same set temperature [symbol] _{Wall condition 1} there is a higher heat transfer coefficient α. The temperature control mechanism would have to operate at a higher cooling intensity. In fast-moving cooling processes, as in the present process, a higher cooling intensity can mean that this doubles due to the strong temperature dependence of the heat transfer coefficient α. This is easily possible when in the area of partial heat transfer and there is a strong dependence of the heat transfer coefficient α on the temperature [symbol] of the wall surface. This can be a source of instability for the temperature controller. It is therefore more advantageous to lower the target temperature [symbol] of the surface from the temperature [symbol] _{Wall condition 1} to the temperature [symbol] _{Wall condition 2}. This means that now, in the case of the aged surface, the temperature control surface 4 is operated at a lower wall temperature [symbol] ₒ, but the same heat is extracted as before in the non-aged case. The stability of the production process can thus be maintained. One would also find oneself in a stable area of the process because with increasing wall temperature [symbol] ₒ in the area of bubble evaporation the intensity of heat transfer increases with the wall temperature [symbol] ₒ. The heat transfer mechanism of bubble evaporation counteracts the rise in wall temperature by increasing the cooling intensity of the water against the wall.

These ageing constraints can already be influenced during the design of the casting tools by including the ageing of the wall material in the control mechanism. Such material changes can, for example, be determined in advance of the design and the associated heat transfer coefficient values a determined. If the surface material of the temperature control surface 4 of section 4.i ages gradually during the production process, the control behaviour of the temperature controller is adjusted step by step.

For example, it is possible to sprinkle or cool the respective subarea 4.i of the temperature control surface 4 with an almost constant intensity when setting the desired temperature. One temperature control task, for example, is to cool a certain section 4.i of the mould rim zone 1 with an almost constant heat transfer coefficient αᵢ because a certain material property of the workpiece is required. Since the heat transfer coefficient αᵢ depends on the surface temperature of the wall material, the corresponding subarea 4.i of the temperature control surface 4 must be cooled at a certain set temperature or within a narrow temperature range of the set temperature. This can be achieved by selectively controlling the water supply to sprinkling nozzle 6 of this section 4.i of the temperature control surface 4 via a valve 11, for example via a solenoid valve 11 as shown in FIG. 4.

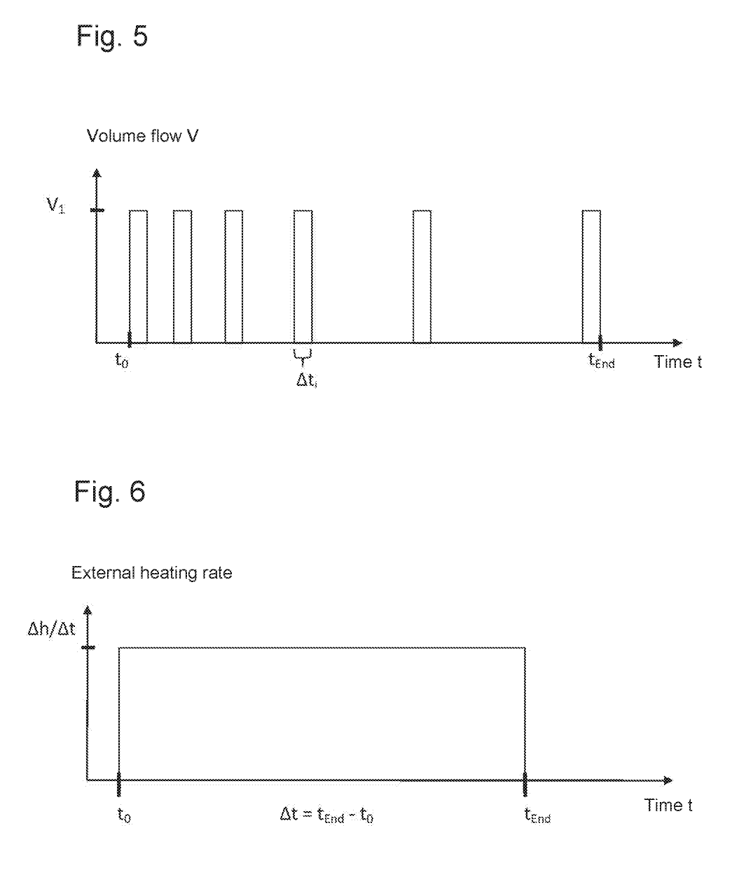

For this purpose it is possible to record the temperatures at one or more suitable measuring points in subarea 4.i of the temperature control surface 4 using sensors 12 such as temperature sensors 12. In FIG. 4 only one temperature sensor 12 is shown as an example. The behaviour to be derived for the control or controlled system can, for example, be based on several temperature measuring points with continuous calculation of a different variable. The control behaviour of the temperature controller or the controlled system can be designed to be stable on the basis of the calculated course of this variable. These sensors 12 can be suitably mounted on and below the surface to measure good and representative values for the temperature [symbol] or the temperature distribution of subarea 4.i of the temperature control surface 4. Via a temperature controller 7, the opening time Δtᵢ of valve 11 or the degree of opening of valve 11 is derived and controlled according to the signal strength of sensor(s) 12 and its deviation from one or more temperature setpoints T_{S} of the temperature [symbol] of the measuring points. FIG. 5 shows schematically and by way of example a discontinuous control of the water volume flow V through the temporary opening and closing of valve 11, for example, using a solenoid valve 11 with only one opening position. The times t₀ and t_{End} mark the start and end of the temperature control in the process cycle. Depending on the desired cooling intensity, the temperature is controlled to a certain target surface temperature of this subarea 4.i of the temperature control surface 4 of the mould rim zone 1.

The heat transfer processes in the corresponding areas of heat transfer, such as partial film evaporation and others, are associated with a rapid reduction in the surface temperature [symbol] ₒ of the wall. The subsequent heat conduction inside the tool rim zone 1 depends on the tool material. With the tool steels currently used for casting moulds, the heat conduction of the tool material is usually lower than the very rapid reduction of the surface temperature [symbol] ₒ due to sprinkling with water. Therefore, the processes of heat transfer of water to the hot wall and that of heat conduction inside the wall must be taken into account and coordinated.

Temperature sensors 12 with low inertia or fast response time are therefore required. This is important, because due to the mechanisms of heat transfer [symbol] ₒ heat is transferred to the wall in different ways depending on the surface temperature. The entire controlled system consisting of measuring elements and final control elements must be able to react in its control behaviour according to the areas of heat transfer and be programmable accordingly. A stable control behaviour must be ensured in order to be able to use the advantages of the heat transfer of liquid water to the hot temperature control surface 4 in the individual subareas 4.i. This means that the regulation of the temperature in the individual areas of heat transfer with their different intensities of heat transfer must be able to be made stable by one or more controllers in order to adjust to the required target temperatures of the subareas 4.i.

The results of thermal simulations can be used to select suitable components for the controlled system. They provide information on the speed of the heat transfer processes taking place under the given flow conditions of water or the respective temperature control fluids used and the resulting requirements on the controlled system.

Furthermore, the opposite process of heating the wall from the side of the moulded part or workpiece via the engraving must be taken into account. This process can hardly be measured directly on the surface of the tool to the melt used via sensors 12. In addition, the melt solidifies, changing the heat transfer of the moulded part to the mould from the engraving side. Due to the low wall thickness of the workpieces, the solidification processes are also fast. Again, the heat transfer coefficients α of the moulding depend on the aggregate state and its temperature [symbol] . In addition, the heat transfer coefficients α of the melt to the steel surface in die-casting depend on the pressure. The solidification process can often only be determined by simulations in which the heat transfer coefficients α can be varied within plausible limits. The data obtained can thus be evaluated or used to select a controlled system for the temperature control surface 4.

Furthermore, control scenarios for an ageing of the temperature control surface 4 or for an intentional change of the temperature control surface 4 must be stored in different subareas 4.i for the control behaviour of the controlled system. All desired variable changes that are relevant for a shift of the Leidenfrost point and the areas of heat transfer must also be available as scenarios for the controlled system and be controllable by it. It must be possible to fall back on it.

Furthermore, the control must also be able to counteract unknown, acting disturbances which influence their stability. These disturbances are, for example, unforeseeable influences during continuous casting operation, such as different casting breaks, different water temperatures of the cooling, cooling water qualities, temperature influences in the foundry, different types of release agent application to the engraving before the casting cycle, varying melt temperature, blowing out the engraving to remove casting residues, occupancy of the temperature control surface 4. Some of these disturbances affect the Leidenfrost temperature [symbol] _{Le}, others affect the controlled system in other ways. Therefore, the stability of the temperature control of the temperature control surface 4 or the subareas 4.i and the control to the specified and changing target temperatures [symbol] is important for optimum heat transfer during the casting process.

If other temperature control media than water are used, their effectiveness can also be influenced by disturbances. Here, too, the controlled system must be able to counteract the disturbances in a stable manner.

Then suitable components of the controlled system can be assembled and the control behaviour of the entire controlled system on the side of the temperature control surface 4 or its subareas 4.i can be determined and optimized by simulating the known influences and random influence of disturbances.

An important question is the orientation of the controlled system. This means the question of the range of heat transfer of the water to the temperature control surface 4, in which the subarea 4.i of the temperature control surface 4 is currently located, if the control has come out of the stable range. This can happen if the controlled system reacts too slowly to an external influence or is too slow to control. This can happen due to ageing of the surface or due to environmental influences on the temperature control surface 4. The areas of heat transfer are shifted. It concerns the measures of regulation for finding back into the stable area of temperature control, from an unwanted area into the intended heat transfer of water to the hot surface. What does an optimal control in order to return to the set temperature [symbol] look like? An orientation routine or a variable for orientation of the controlled system must be carried along which allows it to return to the desired area of heat transfer. A constant adjustment must be made for orientation of the controlled system.

Furthermore, a delay of the measured values for the actual change of the measured variable must be expected and these must be included in the routines for the controlled system. For the temperature control process on the temperature control surface 4, a rapid change in the measured variable must be measured and evaluated using sensors with low inertia. Likewise, measured values are to be made continuously directly below the measuring point of the surface, i.e. in the mould rim zone 1. The appropriate control routine must always be derived from this.

If the temperature is measured with a sensor 12, its change directly at the temperature control surface 4 is faster than within the mould rim zone 1, which results from the heat conduction of the material or the physical material values of the mould rim zone 1. In addition, they are delayed inside the mould rim zone 1. From the temperature curves, the heat flux densities can be calculated as a function of the temperatures. The possible orientation for determining the orientation of the controlled system according to the areas of heat transfer is shown in FIG. 13 as an example for the case of surface sprinkling. The heat flux density q in watts/m² calculated from the temperature curve of at least 2 temperature measuring points [symbol] _{O} on the surface and below in their principal dependence on the surface temperature [symbol] _{O} is shown. If the temperature is [symbol] ₁, the rise to the curve is negative. The increase is to be understood as a change in the heat flux density q after the temperature [symbol] at a given point on the surface. To the left of the Leidenfrost temperature [symbol] _{Le} the temperature [symbol] decreases with rising heat flux density q. This is principally the same with temperature [symbol] ₂ but the amount of the rise is different. The sign of the increase principally does not change up to the burnout point. When being to the left of the burnout point, i.e. in the area of bubble evaporation, the rises are positive depending on the surface temperature [symbol] ₒ, but their amounts also differ, the conditions at temperature [symbol] ₃ and [symbol] ₄ must be compared. At the curve, a rise is drawing symbolically for the point [symbol] ₄,q₄. By continuously determining the temperatures [symbol] at and directly below the surface, orientation within the areas of heat transfer can be carried out, for example, with the rises to the q- [symbol] curve. The routines for the individual areas of heat transfer will be different. If, for example, one is to the right of the Leidenfrost point in the area of stable film evaporation, the increases in heat flux density after the temperature are much lower to constant. The control behaviour for the individual areas of heat transfer will therefore be different and must be adapted accordingly. Stable operation of the control system must be able to be achieved again and again in the event of disturbances. The constant orientation of the controlled system therefore serves to take measures to remain within the stable range of control of the setpoint value or to return to it.

Furthermore, the control behaviour to be adjusted depends on the surfaces used or their materials and their ageing. This is also important for the controlled system and the stable control for dissipating heat from the workpiece. For example, the temperature curves on and below the surface differ if the areas of heat transfer shift with the ageing of the temperature control surface 4.

In principle, orientation in the areas of heat transfer is also possible with other sensors 12 than temperature sensors 12. A sensor system that can be assigned to the individual areas must be selected. The change in measured value in the respective range should also be large enough for an evaluation.

In addition, process-accompanying thermal, etc. simulations are carried out to ensure the plausibility of the control behaviour to be derived and the stability of the control.

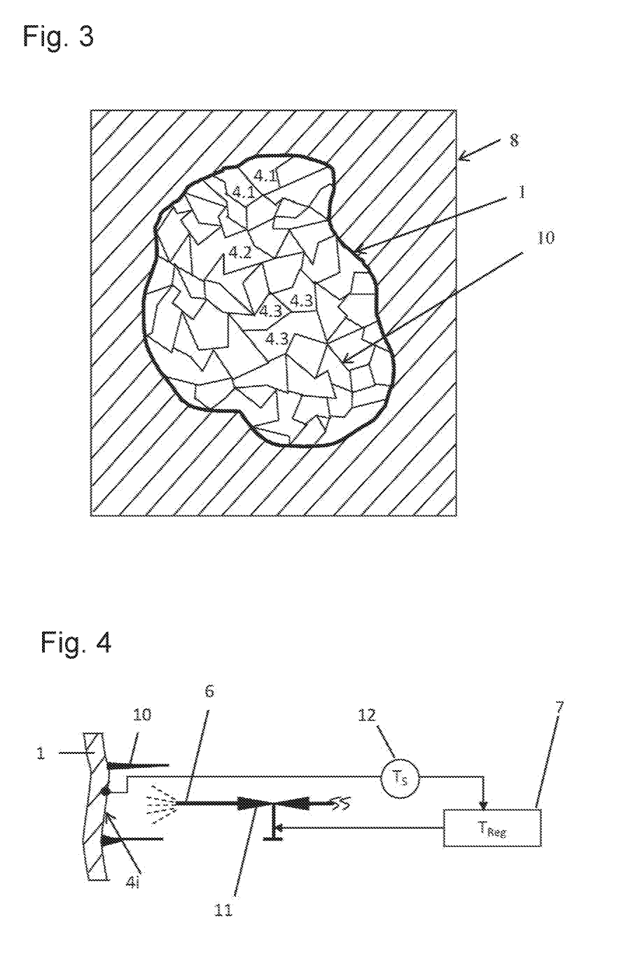

The duration and intensity of cooling of the mould rim zone 1 influence the conditions of the workpiece. Material accumulations of the workpiece, such as thick workpiece walls, can be cooled with particularly high intensity, for example. These include, for example, areas of overflows, which generally have thick walls. At thin workpiece areas, the temperature control surface 4 is cooled with lower intensity. It may be technologically necessary to also slightly heat subareas with low intensity externally. A temperature control task can be to temperature-control a subarea 4.i of the temperature control surface 4 for a certain period of time at a constant thermal heating rate Δh/Δt of an external heater (FIG. 6). The sub-area 4.i must therefore be heated during the period Δtᵢ. The times t₀ and t_{End} mark the start and end of the heating process. The temperature [symbol] of section 4.i of the temperature control surface 4 changes constantly and the temperature [symbol] of the engraving changes accordingly. After the casting has been removed, the result of the temperature control regime can be viewed and evaluated advantageously on the engraving 5 using an infrared camera. However, other sensors 12 can also be inserted into the mould 14 (not shown), which allow a continuous evaluation during the closed mould 14. According to the measurement results, the temperature control regime is changed or optimized in certain subareas 4.i. FIG. 7 (below) shows two setpoint temperatures in two subareas of the temperature control surface 4 for illustration purposes. With the control to these wall temperatures [symbol] ₁ and [symbol] ₂ in the subareas 4.i of the temperature control surface 4, corresponding heating and cooling intensities, for example, according to α₁ and α₂, are transferred to these subareas 4.i of the temperature control surface 4. A different heat transfer can take place in each subarea 4.i of the temperature control surface 4. This means that a different heat transfer coefficient α can be assigned to each sub-area 4.i of the temperature control surface 4 according to FIG. 3.

For example, it is necessary to meet certain temperature specifications for cooling in certain subareas 4.i. It may be necessary to cool certain areas 4.i of the temperature control surface 4 to a greater extent in order to set material properties such as a certain mean dendrite arm distance in the workpiece in order to achieve a special strength of the workpiece. Furthermore, if applicable, it is necessary to set a high cooling intensity locally or to cool with a high heat transfer coefficient α in order to push back the porosity from the area near the wall of the workpiece and to enable subsequent workpiece treatment such as welding or surface finishing.

External heating may be required for sensitive areas of the mould rim zones 1 in which, for example, cold running or streaking of the workpiece must be expected during casting. For this purpose, for example, it is necessary to slightly heat or cool the mould wall at some points in order to eliminate the defect pattern. Influencing such changes is possible with the method according to the invention. A temperature control regime with different types of temperature control in a specific subarea 4.i can also be used. First, for example, the mould is slightly heated to improve filling and then cooled to improve solidification. For this purpose, both external heating and cooling elements are provided for the corresponding subareas 4.i of the temperature control surface 4. For example, an external heating treatment in a subarea 4.i of the temperature control surface 4 and subsequently a cooling treatment with the cooling medium water in subarea 4.i will take place for a limited time. In another subarea 4.i+n adjacent to subarea 4.i, for example, cold compressed air is used for cooling. This ensures that a uniform final cooling temperature [symbol] is achieved based on different high range temperatures [symbol] . The cooling processes can be applied simultaneously in adjacent subareas 4.i of the temperature control surface 4, without mutual interference. Therefore, different temperature control regimes can be applied to the temperature control surface 4.

If, for example, a temperature dependence or a temperature gradient is to be produced on the engraving 5, it may be advantageous to thermally treat certain tool areas separately from the rear space 3 by means of additional external thermal energy, while cooling other subareas 4.i temperature control surface 4. Extensive structural castings often have thin-walled areas in which rapid solidification and inadequate mould filling can be expected. An additional introduction of external thermal energy can be useful for the mould filling process or may be the only way to achieve complete mould filling. After filling the mould, the melt should solidify in a direction so that there is not enough shrinkage porosity in the casting.

The build-up of lateral thermal-mechanical stresses on the engraving 5, which often occur due to unfavourable temperature distribution, is countered by setting a suitable temperature distribution. For example, tensile stresses would result from notches in engraving 5 which are geometrically unfavourably located but required on the workpiece side. These notches often represent a centre of elevated temperature, also called hot spot. They cool down more slowly than the surrounding areas. This uneven cooling causes tensile stresses which are often reduced by cracks in the notch base. The temperature behaviour in these areas can be effectively controlled by local temperature control according to the invention. This means that areas in the wider vicinity of the notch can be cooled less than the potential crack area in the notch. This directly influences the extension of the service life of the moulds 14.

Another common defect on the engraving 5 of die-casting tools is the occurrence of fire crack networks. They are formed with increasing age of the mould 14 as a result of the classic atomisation of a release agent/water mixture onto the hot engraving 5 after casting removal. The subsequent casting of the hot melt requires the shock-like heating of the engraving 5. In the casting cycles, therefore, strong tensile and compressive stresses alternate continuously due to the thermal alternating shock stress on the engraving 5. Through the process according to the invention, cooling takes place in a mild form from the rear space 3 of the mould via the temperature control surface 4 there. It is not necessary to apply a mixture of release agent and water to the engraving 5, but only a release agent concentrate in the form of a short aerosol spray dosage, powder or similar. Through the process according to the invention this error pattern can be countered by saving the classic process step of shock cooling of engraving 5. This is why the process according to the invention extends the service life of the moulds.

In addition to temperature control according to the invention, mould filling can be additionally supported before casting by evacuation of the mould or prior removal of oxygen if increased oxide formation must be expected. It is known that partial oxidation of the melt changes the viscosity in areas where oxides occur.

The temperature control regime of mould 14 runs according to the inventive process independent of the casting and opening times of mould 14 and the removal of the workpiece. It can be optimally influenced at any time on technological requirements of the process regarding intensity and duration of the temperature control. Therefore, all areas of the temperature control surface 4 can be controlled to their optimum temperature control regime or target temperature [symbol] . If it is appropriate, the temperature control regime can be changed. In the case of cooling via sprinkling cooling of certain areas, an optimum amount of water can therefore be sprinkled. Greater cooling would impair the mould temperature control for a desired design of the mould filling and the properties of the casting. The amount of water can thus be optimally maintained. If possible, with a high heat transfer coefficient αᵢ of the respective subarea 4.i, sprinkling is possible, whereby the control of the surface temperature [symbol] ₒ of the respective subarea 4.i of the temperature control surface 4 towards the corresponding target temperature [symbol] takes place. For these reasons, considerable cost and time savings continue to be achieved compared to conventional cooling. On the other hand, a gentle heat transfer can also be selected by controlling a corresponding temperature [symbol] of the temperature control surface 4, which corresponds to a lower heat transfer coefficient αᵢ or a low transferable heat quantity, for example for sensitive areas of the workpiece. Here, for example, temperature control can be carried out gently with cold compressed air. The temperature control regime can be optimally adapted to the technological objectives with the process according to the invention. Target values include, for example, minimum process cycle times, mechanical properties of the workpiece and protection of the mould 14.

The type of temperature control according to the invention does not take place in channels, but represents a flat-type open temperature control of the rear space 3 of the mould 14. This is the only way to react to the usual sudden temperature increases or heat flows from the forming process into the mould rim zone 1 with stable temperature control of subareas 4.i of the temperature control surface. In the case of classic open channel cooling with water, the sudden increase in heat flow from the mould cavity during the moulding process can cause the temperature [symbol] of the channel wall to rise sharply. Depending on the temperature [symbol] of the channel wall, the corresponding mechanism of heat transfer will adjust to the coolant water. There is only a small optimization potential for an optimal use of coolant, because it flows or it is stopped. Sudden removal of the current temperature control medium or replacement by others is generally not possible. A quick reaction of the temperature control to sudden heat flows is therefore not possible. In the case of the classic closed channel cooling with water, a sudden high heat input would lead to a pressure-superimposed temperature increase, and the system pressure of the cooling would increase strongly locally. This means the opening of safety valves when a critical pressure is reached in the cooling system. Here, too, the stable control of cooling is excluded. Since the process according to the invention is an open-pressure cooling system, there is no increase in pressure in the cooling water system: The pressure compensation to the ambient conditions always takes place.

Open cooling is fundamental for the process, otherwise it cannot run in a controlled manner. Under pressure, a closed system would shift the Leidenfrost point. Consequently, the areas of heat transfer would change.

The Leidenfrost point depends on the pressure presently in the system. In a closed system it would change rapidly with a sudden strong flow of heat from the hot workpiece. The pressure increase would be caused by a temperature overlay with the water, resulting in poor to impossible control.

In the present process, the pressure in the rear space 3 of the shell-shaped mould can assume at most that of the environment. By suitable temperature control of the respective subarea 4.i to a setpoint temperature or a temperature distribution in subarea 4.i, rapid cooling of the temperature control surface 4 will take place as long as it is sprinkled or cooled in accordance with the invention. The selected temperature control regime allows an early or suitable reaction to increased heat flows.

For the production of a mould 14, a semi-finished product can be processed, which was produced, for example, in a preceding manufacturing process by means of forming and heat treatment etc. The classic forged steels used for die-casting die construction can also be used in the case of the process according to the invention. The machining operations for the production of the temperature control surfaces 4 of the mould rim zone 1 from rear space 3 are similar to those required for the machining of engraving 5. Therefore, the classical machining tools for mould construction can also be used for machining the temperature control surfaces 4 of the process according to the invention.

However, the moulds 14 according to the invention with mould rim zones 1 can also be produced in an original mould casting process. Production via the original mould process with possible subsequent heat treatment may be possible, provided that the mechanical properties of the mould material, such as hardness, tensile strength and grain size, are sufficient for the intended mould process. If generative processes or 3D processes can be used to produce the entire tool on a larger scale, it is conceivable to produce the entire tool with these processes.

Depending on the technological requirements and the type of temperature control media used, it is necessary to condition the temperature control surface 4 in order to achieve optimum temperature control surfaces 4. Conditioning may be necessary due to the intended use of the mould 14, material properties of the produced workpiece or similar. If, for example, sprinkling cooling is used for cooling, the Leidenfrost point of the temperature control surface 4 of mould 14 must be observed. It depends on the chemical composition of the temperature control surface 4. According to the invention, the Leidenfrost point can be influenced by coating the temperature control surface 4 of mould 14. With it, the other areas of heat transfer change. This can be done by chemical coating, e.g. chemical copper plating or physical coating, e.g. by precipitation of a vapour. Coating is applied directly to the temperature control surface 4. Coating can also be worked into the temperature control surface 4. Depending on the choice of coating of the temperature control surface 4, the Leidenfrost point and the areas of heat transfer are shifted to higher or lower temperatures. This is advantageous, for example, if a high cooling capacity is to be transferred to the mould rim zone 1 at a high temperature level. It can also be advantageous to extend the service life of mould 14 if the cooling temperature of mould rim zone 1 is not to be lowered too much after the respective mould cycle. In different subareas 4.i of the temperature control surface 4 the coating can be different.

Furthermore, the Leidenfrost point of pure liquid cooling fluid water can be changed by soluble additives to the cooling fluid for the given temperature control surface 4 of the mould rim zones 1. Similar to the case of the surface coating, the Leidenfrost point can be shifted to a different temperature [symbol] . The interaction of the water with the surface is changed and the Leidenfrost point and the areas of heat transfer shift. In different subareas 4.i of the temperature control surface 4, cooling can be carried out with water containing various chemical additives. For example, water-soluble polymers are added to the water. The advantage of using water with the dissolved polymers is that adaptable contact of the water with the temperature control surface 4 and thus a changed heat dissipation or a displacement of the areas of heat transfer is made possible.

Preferably demineralized water is used for sprinkling of the temperature control surface. Normal tap water always contains minerals in dissolved form, which can be deposited on the temperature control surface 4 when the cooling water is heated, as the water is heated up to 100° C. when cooling. If these minerals are deposited, this leads to a layer on the temperature control surface 4, which influences the heat transfer and the Leidenfrost temperature [symbol] _{Le}. This leads to a gradual change in the areas of heat transfer. However, the use of tap water is also possible. This requires additives that bind the minerals. In addition, additives can be used in both variants to prevent corrosion of the temperature control surface 4.

According to the invention, moulds already in use which have a cooling system of a different type than the cooling system according to the invention can be equipped with the process according to the invention or in part. This is possible if reworking of the rear space 3 of the classic mould 14 allows it. For example, parts of a classically cooled mould 14 can be equipped with the process according to the invention if, for example, streaking and cold running of a workpiece is to be prevented.

### LIST OF REFERENCE NUMERALS

1—Mould rim zone
2—Cavity
3—Rear space, temperature control space
4—Temperature control surface
4.i, 4.1, 4.2, 4.3—Subarea, subarea surface
5—Contour, engraving
6—Sprinkling nozzle
7—Temperature regulator
8—Solid area of the mould
9—End plate
10—Separating-passing element
11—Valve, solenoid valve
12—Sensor, temperature sensor
13—External heating medium
14—Mould
15—Breakthrough
16—Weld
tᵢ—Time
α, αᵢ—Heat transfer coefficient
[symbol] , [symbol] ᵢ—Temperature
a—Area, breakthrough
A—Rise at point [symbol] ₄,q₄
K—Beginning of area of convection of the water at the wall, with dropping wall temperature
V—Volume flow

1. A method for near-contour surface temperature control of shell-shaped moulds (14) with mould rim zones (1), wherein the temperature control of the mould (14) on a near-contour temperature control surface (4) with adjacent, web-like or wall-like separated subareas (4.i) is effected from the respective rear space (3) of the mould rim zones (1) of the mould (14) and/or the respective mould rim zone (1) of the mould (14) and the shell-shaped moulds (14) are designed in two or more parts with the respective mould rim zones (1), characterised in that
the temperature control as cooling in the form of temperature control on the temperature control surface (4) is locally different in subareas (4.i) the temperature control surface (4) is effected in accordance with the temperature ranges of convection, bubble evaporation, partial and/or stable film evaporation of the liquid cooling fluid water, wherein the temperature control of the temperature control surface (4) and/or the temperature distribution in the individual subareas (4.i) of the temperature control surface (4) is controlled by means of different temperature control regimes of the subareas (4.i) of the temperature control surface (4) and wherein the temperature control takes place in a rear space (3) open towards the surrounding atmosphere.

2. The method according to claim 1,
characterised in that
during temperature control by means of water as the temperature control medium, this is distributed on the temperature control surface (4) and/or on the subareas (4.i) of the temperature control surface (4) by means of extensive sprinkling, so that these are wetted over their entire surface and a liquid film is formed.

3. The method according to claim 1,
characterised in that
the temperature ranges of convection, bubble evaporation, partial and/or stable film evaporation are shifted by the admixture of soluble constituents to the cooling fluid water.

4. The method according to claim 1,
characterised in that
the temperature ranges of convection, bubble evaporation and/or partial and/or stable film evaporation are shifted by a chemical or physical coating of the temperature control surface (4).

5. A device for carrying out the method according to claim 1 for near-contour surface temperature control of shell-shaped moulds (14) with mould rim zones (1), wherein the mould rim zones (1) have a temperature control surface (4) on the rear space (3) opposite the respective engraving (5) or contour (5) with subareas (4.i) and the shell-shaped moulds (14) are designed in two or more parts with the respective mould rim zones (1),
characterised in that
the subareas (4.i) of the temperature control surface (4) have an irregular, polygonal layout plan and are bounded on the side by means of wall-like separating-passing elements (10), the subareas form a polyhedron-like space with the wall-like separating-passing elements (10).

6. The device according to a claim 5,
characterised in that
the separating-passing elements (10) have breakthroughs (15, a).

7. The device according to claim 5,
characterised in that
the separating-passing elements (10) are connected to the temperature control surface (4) and/or worked out from the mould rim zones (1).

8. The device according to claim 5,
characterised in that
the separating-passing elements (10) each have different heights.

9. The device according to claim 5,
characterised in that
the separating-passing elements (10) are flat, wavy and/or concave.

10. The device according to claim 5,
characterised in that
the separating-passing elements (10) have a discontinuous cross-section.

11. The device according to claim 5,
characterised in that
the respective temperature control surface (4) and/or the subareas (4.i) are conditioned by a chemical and/or physical coating and/or by mechanical surface structuring.
